(19) United States
(12) Patent Application Publication
(10) Pub. No.: US 2026/0015529 A1
(43) Pub. Date: Jan. 15, 2026

(54) ADHESIVE SHEET, ADHESIVE SHEET WITH MOLD RELEASE FILM, ADHESIVE SHEET FOR FLEXIBLE IMAGE DISPLAY DEVICE COMPONENT, LAMINATE FOR IMAGE DISPLAY DEVICE, FLEXIBLE IMAGE DISPLAY DEVICE, PHOTOCURABLE ADHESIVE SHEET, AND ADHESIVE COMPOSITION

(71) Applicant: MITSUBISHI CHEMICAL CORPORATION, Tokyo (JP)

(72) Inventors: Kohei HIROSE, Tokyo (JP); Akifumi MATSUSHITA, Tokyo (JP); Kazunari MATSUMURA, Tokyo (JP)

(73) Assignee: MITSUBISHI CHEMICAL CORPORATION, Tokyo (JP)

(21) Appl. No.: 19/333,209

(22) Filed: Sep. 18, 2025

Related U.S. Application Data
(63) Continuation of application No. PCT/JP2024/006801, filed on Feb. 26, 2024.

(30) Foreign Application Priority Data
Mar. 22, 2023 (JP) 2023-045353

(51) Int. Cl. C09J 7/38; C09J 153/00

(52) U.S. Cl. CPC C09J 7/387; C09J 153/00; C09J 2203/326; C09J 2301/30; C09J 2301/302; C09J 2301/40; C09J 2301/416; C09J 2453/00

(57) ABSTRACT

An adhesive sheet is formed of an adhesive composition containing a (meth)acrylic copolymer (A), in which the (meth)acrylic copolymer (A) has a constitutional unit derived from a monomer M which is excited by irradiation with an active energy ray to generate an active species

### CROSS-REFERENCE TO RELATED APPLICATIONS

This application is a continuation application of International Application No. PCT/JP2024/006801, filed on Feb. 26, 2024, which claims the benefit of priority of the prior Japanese Patent Application No. 2023-045353, filed Mar. 22, 2023, the content of which is incorporated herein by reference.

### TECHNICAL FIELD

The present invention relates to an adhesive sheet, an adhesive sheet with a mold release film, an adhesive sheet for a flexible image display device component, a laminate for an image display device, a flexible image display device, a photocurable adhesive sheet, and an adhesive composition.

### BACKGROUND ART

In recent years, an image display device including a curved portion, which uses an organic light emitting diode (OLED) or quantum dots (QD), a flexible image display device capable of folding or rolling up, and the like, has been developed and is widely commercially available.

In such a display device, a plurality of sheet members such as a cover lens, a circular polarizing plate, a contact film sensor, a color filter, and a light emitting element are bonded to each other by a transparent adhesive sheet to form a laminated structure, and when focusing on a certain adhesive sheet, it can be considered as a laminate in which the members and adhesive sheets are laminated.

With regard to the flexible image display device capable of winding, Patent Document 1 discloses an adhesive for a repeatedly bendable device, an adhesive sheet, a bendable layered member, and a repeatedly bendable device, in which a product value of a creep compliance fluctuation value and a relaxation elastic modulus fluctuation value can be set within a suitable range.

Patent Document 2 discloses an adhesive which can be hot melted and with which an adhesive layer having excellent holding power and adhesive force can be formed, where the adhesive contains a (meth)acrylic polymer having a weight-average molecular weight of 50,000 to 1,000,000, which is obtained by polymerizing a macromonomer having a number-average molecular weight of 500 or more and less than 6,000 and a monomer mixture containing a vinyl monomer.

### CITATION LIST

### Patent Documents

Patent Document 1: Japanese Unexamined Patent Application, First Publication No. 2019-123826
Patent Document 2: PCT International Publication No. WO 2015/080244

### SUMMARY OF INVENTION

### Technical Problem

The adhesive sheet used for the flexible image display device is required to be further flexible. However, there is a concern that sensitivity to active energy rays may decrease or shape stability may deteriorate as the adhesive sheet is made more flexible. In the adhesive sheets in the related art, such as Patent Documents 1 and 2, it is difficult to achieve both flexibility and shape stability while ensuring sensitivity to active energy rays.

An object of the present invention is to provide an adhesive sheet having high sensitivity to active energy rays and excellent flexibility and shape stability; and an adhesive sheet with a mold release film, an adhesive sheet for a flexible image display device component, a laminate for an image display device, a flexible image display device, a photocurable adhesive sheet, and an adhesive composition, each of which uses the adhesive sheet.

### Solution to Problem

The present invention has the following aspects.
[1] An adhesive sheet formed of an adhesive composition containing a (meth)acrylic copolymer (A),
in which the (meth)acrylic copolymer (A) has a constitutional unit derived from a monomer M which is excited by irradiation with an active energy ray to generate an active species, and
the following requirements (1) and (2) are satisfied,
the requirement (1): a storage shear modulus (G′(−20° C.)) at −20° C., which is obtained by a dynamic viscoelasticity measurement in a shear mode at a frequency of 1 Hz, is 10 kPa or more and 1,000 kPa or less; and
the requirement (2): a maximum strain value (γₘₐₓ) when a stress of 2 kPa is applied at 60° C. for 600 seconds is less than 80%.
[2] The adhesive sheet according to [1],
in which a storage shear modulus (G′(30° C.)) at 30° C., which is obtained by the dynamic viscoelasticity measurement in the shear mode at the frequency of 1 Hz, is 1,000 kPa or less.
[3] The adhesive sheet according to [1] or [2],
in which a glass transition temperature (Tg) defined by a maximal value of Tan δ, which is obtained by the dynamic viscoelasticity measurement in the shear mode at the frequency of 1 Hz, is −20° C. or lower.
[4] The adhesive sheet according to any one of [1] to [3],
in which a restoration rate calculated by the following expression from the maximum strain value (γₘₐₓ) when the stress of 2 kPa is applied at 60° C. for 600 seconds and a residual strain value (γₘᵢₙ) after 600 seconds from a point of time when the stress is removed is 60% or more,

$$restoration rate ( \% ) = [ ( {γ}_{max} - {γ}_{min} ) / {γ}_{max} ] \times 100 .$$

[5] The adhesive sheet according to any one of [1] to [4],
in which a gel fraction is 30% or more.
[6] The adhesive sheet according to any one of [1] to [5],
in which a contained amount of the constitutional unit derived from the monomer M is 0.01% to 20% by mass with respect to all constitutional units constituting the (meth)acrylic copolymer (A).
[7] The adhesive sheet according to any one of [1] to [6],
in which the monomer M has a structure in which, when being excited by irradiation with an active energy ray, a single bond in the monomer is cleaved and decomposed to generate a radical.
[8] The adhesive sheet according to any one of [1] to [7],
in which the monomer M has a structure in which, when being excited by irradiation with an active energy ray, a hydrogen is extracted from a hydrogen donor in the adhesive composition to generate a radical.
[9] The adhesive sheet according to any one of [1] to [8],
in which the monomer M is represented by Formula (I),

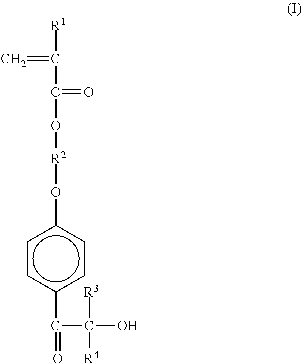

in the formula, R¹ represents a hydrogen atom, a methyl group, or an ethyl group, R² represents a linear or branched alkylene group having 1 to 5 carbon atoms, R³ and R⁴ each independently represent a linear or branched alkyl group having 1 to 5 carbon atoms, and R³ and R⁴ may be bonded to each other to form a ring.
[10] The adhesive sheet according to any one of [1] to [9],
in which the (meth)acrylic copolymer (A) has a constitutional unit derived from a linear or branched alkyl (meth)acrylate (a1) with an alkyl group having 4 to 30 carbon atoms.
[11] The adhesive sheet according to any one of [1] to [10],
in which the (meth)acrylic copolymer (A) is a block copolymer or a graft copolymer.
[12] The adhesive sheet according to any one of [1] to [11],
in which the (meth)acrylic copolymer (A) has a constitutional unit derived from a macromonomer (a9).
[13] The adhesive sheet according to [12],
in which the macromonomer (a9) includes a constitutional unit derived from an alkyl (meth)acrylate with an alkyl group having 9 to 30 carbon atoms.
[14] The adhesive sheet according to any one of [1] to [13],
in which the adhesive composition contains a photocurable compound (B).
[15] The adhesive sheet according to any one of [1] to [14],
in which the adhesive composition contains a photoinitiator (C).
[16] The adhesive sheet according to any one of [1] to [15],
in which the adhesive composition contains a photocurable compound (B) and a photoinitiator (C).
[17] The adhesive sheet according to [14],
in which the photocurable compound (B) includes a polyfunctional urethane (meth)acrylate.
[18] An adhesive sheet with a mold release film, comprising:
the adhesive sheet according to any one of [1] to [17]; and
a mold release film laminated on at least one surface of the adhesive sheet.
[19] An adhesive sheet for a flexible image display device component comprising:
the adhesive sheet according to any one of [1] to [17].
[20] A laminate for an image display device, comprising:
two image display device components; and
the adhesive sheet according to any one of [1] to [17],
in which the two image display device components are laminated through the adhesive sheet, and
at least one of the image display device components has a step with a height difference of 2 μm or more on a contact surface with the adhesive sheet.
[21] A flexible image display device comprising:
the laminate for an image display device according to [20].
[22] A photocurable adhesive sheet formed of an adhesive composition containing a (meth)acrylic copolymer (A),
in which the (meth)acrylic copolymer (A) has a constitutional unit derived from a monomer M which is excited by irradiation with an active energy ray to generate an active species, and
the following requirements (1′) and (2′) are satisfied,
the requirement (1′): when the photocurable adhesive sheet is irradiated with an active energy ray having a wavelength of 365 nm with an irradiation amount within an integrated light amount of 1,000 to 5,000 mJ/cm², a storage shear modulus at −20° C. (G′(−20° C.)), which is obtained by a dynamic viscoelasticity measurement in a shear mode at a frequency of 1 Hz, is 10 kPa or more and 1,000 kPa or less; and
the requirement (2′): when the photocurable adhesive sheet is irradiated with an active energy ray having a wavelength of 365 nm with an irradiation amount within an integrated light amount of 1,000 to 5,000 mJ/cm², a maximum strain value (γₘₐₓ) when a stress of 2 kPa is applied at 60° C. for 600 seconds is less than 80%.
[23] An adhesive composition comprising:
a (meth)acrylic copolymer (A),
in which the (meth)acrylic copolymer (A) has a constitutional unit derived from a monomer M which is excited by irradiation with an active energy ray to generate an active species, and
the following requirements (1″) and (2″) are satisfied,
the requirement (1″): when the adhesive composition is dried to form a photocurable adhesive sheet, and the photocurable adhesive sheet is irradiated with an active energy ray having a wavelength of 365 nm with an irradiation amount within an integrated light amount of 1,000 to 5,000 mJ/cm² to form an adhesive sheet, a storage shear modulus at −20° C. (G′(−20° C.)), which is obtained by a dynamic viscoelasticity measurement in a shear mode at a frequency of 1 Hz, is 10 kPa or more and 1,000 kPa or less; and
the requirement (2″): when the adhesive composition is dried to form a photocurable adhesive sheet, and the photocurable adhesive sheet is irradiated with an active energy ray having a wavelength of 365 nm with an irradiation amount within an integrated light amount of 1,000 to 5,000 mJ/cm² to form an adhesive sheet, a maximum strain value (γₘₐₓ) when a stress of 2 kPa is applied at 60° C. for 600 seconds is less than 80%.

### Advantageous Effects of Invention

According to the present invention, it is possible to provide an adhesive sheet having high sensitivity to active energy rays and capable of being cured with high efficiency; and an adhesive sheet with a mold release film, an adhesive sheet for a flexible image display device component, a laminate for an image display device, a flexible image display device, a photocurable adhesive sheet, and an adhesive composition, each of which uses the adhesive sheet.

### DESCRIPTION OF EMBODIMENTS

Definitions of the following terms apply throughout the specification and claims.

“(Meth)acrylate” is a generic term for acrylate and methacrylate. The same applies to “(meth)acryloyl group”, “(meth)acrylic acid”, “(meth)acrylonitrile”, and “(meth)acrylamide”.

“(Meth)acrylic copolymer” means a copolymer having a constitutional unit derived from a (meth)acrylic monomer. The (meth)acrylic copolymer may further have constitutional units derived from monomers other than (meth)acrylic monomers (for example, styrene and the like).

“(Meth)acrylic monomer” means a monomer having a (meth)acryloyl group.

“Vinyl monomer” means a compound having an ethylenically unsaturated bond (polymerizable carbon-carbon double bond).

The “graft copolymer” is a polymer having one or more blocks connected to a main chain polymer structure as a side chain polymer structure. The structures of the main chain polymer and the side chain polymer may be different from each other or may be the same as each other. A method for producing the graft copolymer is not particularly limited; and examples thereof include a method in which a macromonomer having a radical polymerizable double bond at a terminal is produced as a side chain polymer structure, and is then subjected to radical polymerization with a monomer serving as a constitutional unit of a main chain polymer, a method in which a main chain polymer having a reaction point and a macromonomer having a reaction point are produced in advance, and then the main chain polymer and the macromonomer are reacted with each other, and a method in which, after producing a main chain polymer, a radical is generated on the main chain polymer using an initiator having a hydrogen abstraction ability, and a monomer serving as a constitutional unit of a side chain polymer is reacted to produce a side chain polymer structure.

The expression “to” indicating a numerical value range means that numerical values described before and after the expression are included as a lower limit value and an upper limit value, and also includes the meaning of “preferably equal to or more than the lower limit value” or “preferably equal to or less than the upper limit value”.

In addition, when described as “x or more” (x is any number), unless otherwise specified, the description includes the meaning of “preferably more than x”; and when described as “y or less” (y is any number), unless otherwise specified, the description includes the meaning of “preferably less than y”.

Furthermore, “x and/or y (x and y are optional configurations)” means at least one of x or y, and means three cases of only x, only y, and x and y.

### <Adhesive Sheet>

An embodiment of the present invention relates to an adhesive sheet.

The adhesive sheet according to the embodiment is formed of an adhesive composition containing a (meth)acrylic copolymer (A).

The (meth)acrylic copolymer (A) has a constitutional unit derived from a monomer M which is excited by irradiation with an active energy ray to generate an active species. Therefore, when the (meth)acrylic copolymer (A) is irradiated with active energy rays, the constitutional unit derived from the monomer M is excited to generate an active species, and the (meth)acrylic copolymer (A) acts as a photoinitiator.

As a result, with the adhesive composition according to the present embodiment, it is possible to obtain an adhesive sheet which has excellent sensitivity to active energy rays, is easily cured by irradiation with active energy rays, and has excellent shape stability and excellent restoring properties to quickly recover to a flat state when performing a folding operation.

Furthermore, since the curing reaction sufficiently proceeds without separately adding a photoinitiator or by adding a very small amount of the photoinitiator, it is possible to suppress bleed-out of the photoinitiator or a decrease in cohesive force due to the photoinitiator.

### [(Meth)Acrylic Copolymer (A)]

The (meth)acrylic copolymer (A) has a constitutional unit derived from the monomer M (hereinafter, also referred to as “monomer M unit”).

The monomer M is excited by irradiation with active energy rays to generate an active species. The monomer M can also be said to be a monomer having a structure which is excited by irradiation with active energy rays to generate an active species.

The monomer M typically has the structure which is excited by irradiation with active energy rays to generate an active species, and a radically polymerizable functional group. Examples of the radically polymerizable functional group include a functional group having an ethylenically unsaturated bond, such as a (meth)acryloyl group and a vinyl group.

Examples of the active species include a radical, a cation, and an anion, and a radical is preferable from the viewpoint of reactivity.

As a structure which is excited by irradiation with active energy rays to generate a radical (hereinafter, also referred to as “radical generating group”), a structure derived from a known photoradical generator can be used. Examples thereof include a structure which generates a radical by cleaving and decomposing a single bond thereof in a case of being excited by irradiation with active energy rays, such as an acylphosphine oxide structure, an α-aminoacetophenone structure, an α-hydroxyacetophenone structure, and a benzyl ketal structure; a structure which generates a radical by extracting hydrogen from a hydrogen donor in the adhesive composition in a case of being excited by irradiation with active energy rays, such as a benzophenone structure, a thioxanthone structure, an anthraquinone structure, and a phenyl glyoxylate structure; and an oxime ester structure.

Examples of the hydrogen donor in the adhesive composition include, among functional groups in the constitutional units constituting the (meth)acrylic copolymer (A), a functional group in which hydrogen is directly bonded to carbon, such as an alkyl group; and an organic functional group having a hydroxyl group, an amino group, or an ether bond, which is generally used as a hydrogen donating group. In particular, from the viewpoint of easily donating the hydrogen, a functional group having a hydroxyl group, an amino group, or an ether bond is preferable. In addition, the ether bond tends to have hydrogen of a hydrocarbon structure, which is adjacent to the ether bond and thus easily extracted, and the hydrogen donating group including the ether bond is preferably a structure having such hydrogen. In addition, the compound having the above-described functional group may be separately added as the hydrogen donor.

From the viewpoint of suppressing the generation of decomposition products, the radical generating group preferably has a structure which generates a radical by extracting hydrogen from the hydrogen donor in the adhesive composition in a case of being excited by irradiation with active energy rays; and among these, from the viewpoint of suppressing coloration, a benzophenone structure or a phenylglioxylate structure is preferable, and a benzophenone structure is particularly preferable.

On the other hand, from the viewpoint of improving the sensitivity of the adhesive sheet to active energy rays and the adhesive force, the radical generating group preferably has a structure which generates a radical by cleaving and decomposing a single bond thereof in a case of being excited by irradiation with active energy rays; and among these, from the viewpoint of suppressing coloration, an α-hydroxyacetophenone structure or a benzyl ketal structure is preferable, and an α-hydroxyacetophenone structure is particularly preferable.

The monomer M is preferably a monomer represented by Formula (I).

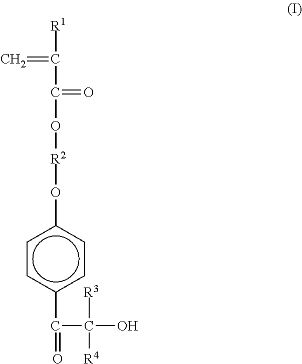

In Formula (I), R¹ represents a hydrogen atom, a methyl group, or an ethyl group. Among the above, a hydrogen atom or a methyl group is preferable, and a methyl group is particularly preferable.

In Formula (I), R² represents a linear or branched alkylene group having 1 to 5 carbon atoms. Among the above, from the viewpoint of polymerizability when obtaining the (meth)acrylic copolymer (A) and reactivity with an ethylenically unsaturated group, an ethylene group, a propane-1,3-diyl group, a butane-1,3-diyl group, or a butane-1,4-diyl group is preferable, and an ethylene group is more preferable.

In Formula (I), R³ and R⁴ each independently represent a linear or branched alkyl group having 1 to 5 carbon atoms.

R³ and R⁴ may be bonded to each other to form a ring. The ring formed by R³ and R⁴ preferably has 5 to 8 carbon atoms, and more preferably has 6 carbon atoms.

From the viewpoint of reactivity with an ethylenically unsaturated group described later and ease of availability, it is preferable that R³ and R⁴ are each independently a methyl group or an ethyl group, or R³ and R⁴ are bonded to each other to form a cyclohexane ring together with a carbon atom to which R³ and R⁴ are bonded; it is more preferable that at least one of R³ or R⁴ is a methyl group; and it is still more preferable that both R³ and R⁴ are methyl groups.

Specific examples of the monomer represented by Formula (I) include 2-[4-(2-hydroxy-2-methyl-1-oxopropyl)phenoxy]ethyl methacrylate and 2-[4-(2-hydroxy-2-methyl-1-oxopropyl)phenoxy]ethyl acrylate.

A contained amount of the monomer M unit in the (meth)acrylic copolymer (A) is preferably 0.01% to 20% by mass, more preferably 0.03% to 10% by mass, still more preferably 0.05% to 5% by mass, particularly preferably 0.08% to 3% by mass, and most preferably 0.1% to 2% by mass with respect to 100% by mass of all constitutional units constituting the (meth)acrylic copolymer (A). When the contained amount of the monomer M unit is equal to or more than the above-described lower limit value, the sensitivity to active energy rays and the shape stability are more excellent; and when the contained amount of the monomer M unit is equal to or less than the above-described upper limit value, compatibility with other components is more excellent.

From the viewpoint of obtaining flexibility, the (meth)acrylic copolymer (A) preferably has, in addition to the monomer M unit, a constitutional unit derived from an alkyl (meth)acrylate (a1) with an alkyl group having 4 to 30 carbon atoms (hereinafter, also referred to as “(a1) unit”).

In addition, from the viewpoint of obtaining excellent adhesive properties, it is preferable that the (meth)acrylic copolymer (A) has a constitutional unit derived from any one or more copolymerizable monomers selected from the group consisting of a carboxy group-containing monomer (a2), a hydroxyl group-containing monomer (a3), a nitrogen-containing monomer (a4), an epoxy group-containing monomer (a5), a vinyl monomer (a6), an alkyl (meth)acrylate monomer (a7) with an alkyl group having 1 to 3 carbon atoms, an alicyclic monomer (a8), a macromonomer (a9), and other copolymerizable monomers (a10), in addition to the monomer M unit and the (a1) unit.

Among the above-described copolymerizable monomers, it is preferable to have any one or more selected from the group consisting of the carboxy group-containing monomer (a2), the hydroxyl group-containing monomer (a3), and the nitrogen-containing monomer (a4).

In addition, it is more preferable to not have the carboxy group-containing monomer (a2), and have any one or more selected from the group consisting of the hydroxyl group-containing monomer (a3) and the nitrogen-containing monomer (a4). When the carboxy group-containing monomer (a2) is not contained and any one or more selected from the group consisting of the hydroxyl group-containing monomer (a3) and the nitrogen-containing monomer (a4) are contained, it is possible to achieve anticorrosion characteristics, adhesiveness, and moisture-heat whitening properties when the adherend contains a component having corrosiveness such as metal.

Furthermore, when containing at least one of the hydroxyl group-containing monomer (a3) or the nitrogen-containing monomer (a4), the hydroxyl group-containing monomer (a3) and the nitrogen-containing monomer (a4) form a non-covalent bond such as a hydrogen bond, thereby enhancing the cohesive force, which is preferable.

The above-described alkyl (meth)acrylate (a1) is a linear or branched alkyl (meth)acrylate in which the number of carbon atoms in the alkyl group is 4 to 30, and is represented by Formula (II).

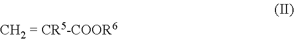

(in the formula, R⁵ represents a hydrogen atom or a methyl group, and R⁶ represents a linear or branched alkyl group having 4 to 30 carbon atoms)

Examples of the alkyl (meth)acrylate represented by Formula (II) include linear alkyl (meth)acrylates such as n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, undecyl (meth)acrylate, lauryl (meth)acrylate, n-tridecyl (meth)acrylate, n-tetradecyl (meth)acrylate, cetyl (meth)acrylate, stearyl (meth)acrylate, icosyl (meth)acrylate, henicosyl (meth)acrylate, and behenyl (meth)acrylate; and branched alkyl (meth)acrylates such as sec-butyl (meth)acrylate, isobutyl (meth)acrylate, tert-butyl (meth)acrylate, isopentyl (meth)acrylate, neopentyl (meth)acrylate, 2-ethylhexyl (meth)acrylate, isooctyl (meth)acrylate, isononyl (meth)acrylate, isodecyl (meth)acrylate, isostearyl (meth)acrylate, isoicosyl (meth)acrylate, butyloctyl (meth)acrylate, isomyristyl (meth)acrylate, isocetyl (meth)acrylate, hexyldecyl (meth)acrylate, isostearyl (meth)acrylate, octyldecyl (meth)acrylate, octyldodecyl (meth)acrylate, and isobehenyl (meth)acrylate. These may be used alone or in combination of two or more kinds thereof.

Among the above, from the viewpoint of balancing adhesiveness and flexibility, a linear or branched alkyl (meth)acrylate in which the number of carbon atoms in the alkyl group is preferably 4 to 20, more preferably 5 to 18, particularly preferably 6 to 16, and most preferably 7 to 14 can be used. For example, n-butyl (meth)acrylate, n-pentyl (meth)acrylate, n-hexyl (meth)acrylate, n-octyl (meth)acrylate, n-nonyl (meth)acrylate, decyl (meth)acrylate, lauryl (meth)acrylate, sec-butyl (meth)acrylate, isobutyl (meth)acrylate, tert-butyl (meth)acrylate, isopentyl (meth)acrylate, neopentyl (meth)acrylate, 2-ethylhexyl (meth)acrylate, isooctyl (meth)acrylate, isononyl (meth)acrylate, or isodecyl (meth)acrylate is preferable.

In addition, from the viewpoint of balancing flexibility and restoring properties, it is particularly preferable to use a linear alkyl (meth)acrylate and a branched alkyl (meth)acrylate.

A contained amount of the (a1) unit in the (meth)acrylic copolymer (A) is preferably 5% to 95% by mass, more preferably 10% to 90% by mass, still more preferably 15% to 85% by mass, and particularly preferably 20% to 80% by mass with respect to 100% by mass of all constitutional units constituting the (meth)acrylic copolymer (A). When the contained amount of the (a1) unit is equal to or more than the above-described lower limit value, the flexibility tends to be excellent, and even when the adherend has unevenness, unevenness followability tends to be excellent. When the contained amount of the (a1) unit is equal to or less than the above-described upper limit value, the effect of the copolymerizable monomer is easily obtained, and the adhesive composition tends to have excellent adhesive force and cohesive force. The lower limit and upper limit of the above-described contained amount of the (a1) unit can be arbitrarily combined.

Examples of the above-described carboxy group-containing monomer (a2) include (meth)acrylic acid, 2-acryloyloxyethyl hexahydrophthalic acid, 2-(meth)acryloyloxyethyl maleic acid, 2-(meth)acryloyloxypropyl maleic acid, 2-(meth)acryloyloxyethyl succinic acid, 2-(meth)acryloyloxypropyl succinic acid, crotonic acid, fumaric acid, maleic acid, and itaconic acid. These may be used alone or in combination of two or more kinds thereof.

Examples of the above-described hydroxyl group-containing monomer (a3) include hydroxyalkyl (meth)acrylates such as 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate; caprolactone-modified hydroxy (meth)acrylates such as caprolactone-modified 2-hydroxyethyl (meth)acrylate; oxyalkylene-modified (meth)acrylates such as diethylene glycol (meth)acrylate and polyethylene glycol (meth)acrylate; primary hydroxyl group-containing (meth)acrylates such as 2-acryloyloxyethyl-2-hydroxyethyl phthalate; secondary hydroxyl group-containing (meth)acrylates such as 2-hydroxypropyl (meth)acrylate, 2-hydroxybutyl (meth)acrylate, and 3-chloro-2-hydroxypropyl (meth)acrylate; tertiary hydroxyl group-containing (meth)acrylates such as 2,2-dimethyl 2-hydroxyethyl (meth)acrylate; and vinyl ethers such as 2-hydroxyethyl vinyl ether, diethylene glycol monovinyl ether, and 4-hydroxybutyl vinyl ether. These can be used alone or in combination of two or more kinds thereof.

The adhesive sheet can be improved in adhesive force and can suppress moisture-heat whitening by the hydroxyl group-containing monomer (a3).

Among the above-described hydroxyl group-containing monomers (a3), a hydroxyl group-containing monomer having, in a hydroxyalkyl group, 1 to 10 carbon atoms, more preferably 1 to 6 carbon atoms, and particularly preferably 2 to 4 carbon atoms, is preferable. For example, 2-hydroxyethyl (meth)acrylate, 4-hydroxybutyl (meth)acrylate, 2-hydroxypropyl (meth)acrylate, 2-hydroxyethyl vinyl ether, diethylene glycol monovinyl ether, or 4-hydroxybutyl vinyl ether is preferable; and a primary hydroxyl group-containing (meth)acrylate, for example, 2-hydroxyethyl (meth)acrylate or 4-hydroxybutyl (meth)acrylate, is particularly preferable.

From the viewpoint of imparting adhesiveness and moisture-heat whitening resistance, a contained amount of the constitutional unit derived from the above-described hydroxyl group-containing monomer (a3) in the (meth)acrylic copolymer (A) is preferably 0.1% to 30% by mass, more preferably 0.5% to 25% by mass, still more preferably 1% to 10% by mass, and particularly preferably 2% to 7% by mass with respect to 100% by mass of all constitutional units constituting the (meth)acrylic copolymer (A).

Examples of the above-described nitrogen-containing monomer (a4) include amino group-containing monomers, amide group-containing monomers, isocyanate group-containing monomers, and (meth)acrylonitrile. The adhesive sheet can be improved in cohesive force and can suppress moisture-heat whitening by the nitrogen-containing monomer (a4). These may be used alone or in combination of two or more kinds thereof.

Examples of the above-described amino group-containing monomer include primary amino group-containing (meth)acrylates such as aminomethyl (meth)acrylate and aminoethyl (meth)acrylate; secondary amino group-containing (meth)acrylates such as tert-butylaminoethyl (meth)acrylate and tert-butylaminopropyl (meth)acrylate; tertiary amino group-containing (meth)acrylates such as ethylaminoethyl (meth)acrylate, dimethylaminoethyl (meth)acrylate, diethylaminoethyl (meth)acrylate, dimethylaminopropyl (meth)acrylate, diethylaminopropyl (meth)acrylate, and dimethylaminopropyl acrylamide; and N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylacetamides, N-vinylcaprolactam, and the like.

Examples of the above-described amide group-containing monomer include (meth)acrylamide; N-alkyl (meth)acrylamides such as N-methyl (meth)acrylamide, N-ethyl (meth)acrylamide, N-propyl (meth)acrylamide, N-n-butyl (meth)acrylamide, diacetone (meth)acrylamide, and N,N′-methylene bis(meth)acrylamide; N,N-dialkyl (meth)acrylamides such as N,N-dimethyl (meth)acrylamide, N,N-diethyl (meth)acrylamide, N,N-dipropyl (meth)acrylamide, N,N-ethylmethyl acrylamide, and N,N-diallyl (meth)acrylamide; hydroxyalkyl (meth)acrylamides such as N-hydroxymethyl (meth)acrylamide and N-hydroxyethyl (meth)acrylamide; alkoxyalkyl (meth)acrylamides such as N-methoxymethyl (meth)acrylamide and N-(n-butoxymethyl) (meth)acrylamide; and maleimide or a derivative thereof.

Examples of the above-described isocyanate group-containing monomer include 2-(meth)acryloyloxyethyl isocyanate and an alkylene oxide adduct thereof. The isocyanate group may be protected with a blocking agent such as methyl ethyl ketone oxime, 3,5-dimethylpyrazole, 1,2,4-triazole, and diethyl malonate.

Among the above, from the viewpoint of having a sensitizing action of a hydrogen abstraction reaction described later and thus being capable of efficiently forming crosslinking, a monomer having a tertiary nitrogen atom is preferable; and for example, a tertiary amino group-containing (meth)acrylate, N,N-dialkyl (meth)acrylamide, N-vinylpyrrolidone, or acryloylmorpholine is particularly preferable.

From the viewpoint of imparting cohesive force and moisture-heat whitening resistance, a contained amount of the constitutional unit derived from the above-described nitrogen-containing monomer (a4) in the (meth)acrylic copolymer (A) is preferably 0.1% to 15% by mass, more preferably 0.5% to 13% by mass, still more preferably 1% to 10% by mass, and particularly preferably 2% to 7% by mass with respect to 100% by mass of all constitutional units constituting the (meth)acrylic copolymer (A).

Examples of the above-described epoxy group-containing monomer (a5) include glycidyl (meth)acrylate, methylglycidyl (meth)acrylate, 3,4-epoxycyclohexylmethyl (meth)acrylate, and 4-hydroxybutyl (meth)acrylate glycidyl ether. These may be used alone or in combination of two or more kinds thereof.

Examples of the above-described vinyl monomer (a6) include a compound having a vinyl group in the molecule. Examples of such a compound include vinyl ester monomers such as vinyl acetate, vinyl propionate, vinyl laurate, and vinyl stearate; and aromatic vinyl monomers such as styrene, chlorostyrene, chloromethylstyrene, α-methylstyrene, and other substituted styrenes. These may be used alone or in combination of two or more kinds thereof.

Examples of the above-described alkyl (meth)acrylate monomer (a7) with an alkyl group having 1 to 3 carbon atoms include methyl (meth)acrylate, ethyl (meth)acrylate, n-propyl (meth)acrylate, and i-propyl (meth)acrylate. These may be used alone or in combination of two or more kinds thereof.

From the viewpoint of imparting cohesive force to the adhesive sheet, a contained amount of the constitutional unit derived from the above-described alkyl (meth)acrylate monomer (a7) in the (meth)acrylic copolymer (A) is preferably 0.1% to 15% by mass, more preferably 0.5% to 13% by mass, still more preferably 1% to 10% by mass, and particularly preferably 2% to 7% by mass with respect to 100% by mass of all constitutional units constituting the (meth)acrylic copolymer (A).

Examples of the above-described alicyclic monomer (a8) include cyclohexyl (meth)acrylate, 3,3,5-trimethylcyclohexyl (meth)acrylate, isobornyl (meth)acrylate, dicyclopentanyl (meth)acrylate, dicyclopentenyloxyethyl (meth)acrylate, tert-butylcyclohexyl (meth)acrylate, and adamantyl (meth)acrylate. These may be used alone or in combination of two or more kinds thereof.

From the viewpoint of imparting cohesive force to the adhesive sheet, a contained amount of the constitutional unit derived from the above-described alicyclic monomer (a8) in the (meth)acrylic copolymer (A) is preferably 0.1% to 15% by mass, more preferably 0.5% to 13% by mass, still more preferably 1% to 10% by mass, and particularly preferably 2% to 7% by mass with respect to 100% by mass of all constitutional units constituting the (meth)acrylic copolymer (A).

The above-described macromonomer (a9) is a monomer in which the number of carbon atoms in a side chain can be easily set to, for example, 20 or more when polymerized into the (meth)acrylic copolymer (A). By using the macromonomer (a9), the (meth)acrylic copolymer can be made into a graft copolymer having a segment including the constitutional unit derived from the macromonomer (a9). It is preferable to use a graft copolymer from the viewpoint that the cohesive force of the (meth)acrylic copolymer (A) is improved and the cohesive force of the adhesive sheet is easily increased.

The characteristics of the main chain and the side chain of the graft copolymer can be changed depending on the selection of the macromonomer (a9) and the other monomers, and on the blending ratio thereof.

In the present invention, the total contained amount of the monomer M unit and the (a1) unit to (a9) unit does not exceed 100% by mass.

It is preferable that the above-described macromonomer (a9) has a skeleton component composed of an acrylic copolymer or a vinyl-based polymer. Examples of a skeleton component of the macromonomer include those described in the monomer M, the alkyl (meth)acrylate (a1) with an alkyl having 4 to 30 carbon atoms, the vinyl monomer (a6), the alkyl (meth)acrylate monomer (a7) with an alkyl group having 1 to 3 carbon atoms, and the alicyclic monomer (a8).

Among the above, it is preferable to use an alkyl (meth)acrylate with an alkyl group having 1 to 8 carbon atoms, an alicyclic monomer, or an aromatic monomer such as styrene, from the viewpoint that an adhesive sheet having excellent cohesive force can be obtained.

On the other hand, it is preferable to use an alkyl (meth)acrylate having 9 to 30 carbon atoms from the viewpoint that an adhesive sheet having excellent flexibility while having an appropriate cohesive force can be obtained.

These can be used alone or in combination of two or more kinds thereof.

The macromonomer has a radically polymerizable functional group or a functional group such as a hydroxyl group, an isocyanate group, an epoxy group, a carboxy group, an amino group, an amide group, and a thiol group. The macromonomer preferably has a radically polymerizable functional group which can be copolymerized with other monomers. One, two, or more kinds of the radically polymerizable functional groups may be contained, and among these, one kind of the radically polymerizable functional group is particularly preferable. Even when the macromonomer has a functional group, the macromonomer may contain one, two, or more functional groups; among these, it is particularly preferable that the macromonomer contains one functional group.

In addition, the macromonomer may contain either one of the radically polymerizable functional group or the functional group, or may contain both.

A weight-average molecular weight (Mw) of the macromonomer (a9) is preferably 1,000 or more and 40,000 or less, more preferably 1,500 or more and 20,000 or less, and still more preferably 2,000 or more and 15,000 or less.

The weight-average molecular weight of the macromonomer (a9) is a value in terms of standard polystyrene, which is measured by gel permeation chromatography (GPC).

As the macromonomer (a9), a macromonomer produced by a known method may be used, or a commercially available macromonomer (for example, a macromonomer manufactured by TOAGOSEI CO., LTD.) may be used.

A contained amount of the constitutional unit derived from the above-described macromonomer (a9) in the (meth)acrylic copolymer (A) is preferably 1% to 30% by mass, more preferably 3% to 20% by mass, and still more preferably 5% to 15% by mass with respect to 100% by mass of all constitutional units constituting the (meth)acrylic copolymer (A). When the contained amount is equal to or more than the above-described lower limit value, the force of phase separation between the segment including the constitutional unit derived from the macromonomer (a9) and a segment consisting of other constitutional units is increased, and thus shape retention of the adhesive sheet in a non-bonded state tends to be more excellent. When the contained amount is equal to or less than the above-described upper limit value, the unevenness followability during bonding tends to be more excellent. The lower limit and upper limit of the above-described contained amount can be arbitrarily combined.

Examples of the other copolymerizable monomers (a10) include a (meth)acrylate having an alkoxyalkylene glycol skeleton, such as methoxydiethylene glycol (meth)acrylate, methoxypolyethylene glycol (meth)acrylate, butoxypolyethylene glycol (meth)acrylate, methoxypolypropylene glycol (meth)acrylate, butoxypolypropylene glycol (meth)acrylate, methoxypolytetramethylene glycol (meth)acrylate, butoxypolytetramethylene glycol (meth)acrylate, methoxypolyoxyethylene polyoxypropylene glycol (meth)acrylate, and butoxypolyoxyethylene polyoxypropylene glycol (meth)acrylate; and a heterocyclic ring-containing (meth)acrylate such as tetrahydrofurfuryl (meth)acrylate. These can be used alone or in combination of two or more kinds thereof.

A weight-average molecular weight (Mw) of the (meth)acrylic copolymer (A) is preferably 50,000 or more and 2,000,000 or less, more preferably 100,000 or more and 1,500,000 or less, and still more preferably 300,000 or more and 1,000,000 or less. When the weight-average molecular weight of the (meth)acrylic copolymer (A) is equal to or more than the above-described lower limit value, durability of the adhesive sheet after bonding tends to be favorable. When the weight-average molecular weight of the (meth)acrylic copolymer (A) is equal to or less than the above-described upper limit value, moldability during manufacturing of the adhesive sheet tends to be improved. The lower limit and upper limit of the above-described weight-average molecular weight can be arbitrarily combined.

The weight-average molecular weight of the (meth)acrylic copolymer (A) is a value in terms of standard polystyrene, which is measured by gel permeation chromatography (GPC).

A melt viscosity of the (meth)acrylic copolymer (A) at 130° C. is preferably 20 Pa·s or more and 800 Pa·s or less, more preferably 50 Pa·s or more and 600 Pa·s or less, and still more preferably 100 Pa·s or more and 500 Pa·s or less. When the melt viscosity of the (meth)acrylic copolymer (A) at 130° C. is within the above-described range, it is possible to perform coating by a hot melt method in which an adhesive composition containing the (meth)acrylic copolymer (A) is heated and applied as it is. The lower limit and upper limit of the above-described melt viscosity can be arbitrarily combined.

The melt viscosity can be measured, for example, using a viscoelasticity measuring apparatus Rheosol-G5000 manufactured by UBM.

A method of producing the (meth)acrylic copolymer (A) is not particularly limited, and a known polymerization method can be used.

As the polymerization method, a known polymerization method such as a solution polymerization method, a suspension polymerization method, and an emulsion polymerization method can be used. In order to be used as an adhesive sheet, a solution polymerization method is preferable.

A contained amount of the (meth)acrylic copolymer (A) in the adhesive composition forming the adhesive sheet according to the embodiment is preferably 50% to 99.5% by mass, more preferably 75% to 99% by mass, and still more preferably 90% to 98% by mass with respect to 100% by mass of the adhesive composition. The lower limit and the upper limit of the contained amount of the (meth)acrylic copolymer (A) can be arbitrarily combined.

### [Photocurable Compound (B)]

The adhesive composition forming the adhesive sheet preferably contains a photocurable compound (B) in addition to the (meth)acrylic copolymer (A).

When containing the photocurable compound (B), curing efficiency by the active energy rays can be improved, and the cohesive force after the active energy ray curing is improved, whereby the shape stability and the restoring properties can be improved.

However, when the (meth)acrylic copolymer (A) can sufficiently form a crosslinking structure either intramolecularly or intermolecularly through the action of the monomer M unit in the (meth)acrylic copolymer (A), a photoinitiator (C) described later, or the like, it is not necessary to contain the photocurable compound (B).

The photocurable compound (B) is a compound having one or more radically polymerizable groups. As the radically polymerizable group, a (meth)acryloyl group is preferable.

Examples of the photocurable compound (B) include a monofunctional (meth)acrylate and a polyfunctional (meth)acrylate. From the viewpoint that the crosslinking structure can be efficiently formed, a polyfunctional (meth)acrylate is preferable. Examples of the monofunctional (meth)acrylate include a monofunctional (meth)acrylate monomer and a monofunctional (meth)acrylate oligomer. Examples of the polyfunctional (meth)acrylate include a polyfunctional (meth)acrylate monomer and a polyfunctional (meth)acrylate oligomer. These may be used alone or in combination of two or more kinds thereof.

Examples of the polyfunctional (meth)acrylate monomer include 1,4-butanediol di(meth)acrylate, glycol di(meth)acrylate, neopentyl glycol di(meth)acrylate, glycerol glycidyl ether di(meth)acrylate, 1,6-hexanediol di(meth)acrylate, 1,9-nonanediol di(meth)acrylate, tricyclodecane dimethacrylate, tricyclodecane dimethanol di(meth)acrylate, bisphenol A polyethoxy di(meth)acrylate, bisphenol A polypropoxy di(meth)acrylate, bisphenol F polyethoxy di(meth)acrylate, ethylene glycol di(meth)acrylate, neopentyl glycol di(meth)acrylate, trimethylolpropane trioxyethyl (meth)acrylate, F-caprolactone-modified tris(2-hydroxyethyl)isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, polypropylene glycol di(meth)acrylate, polytetramethylene glycol di(meth)acrylate, tris(acryloxyethyl)isocyanurate, dipentaerythritol hexa(meth)acrylate, dipentaerythritol penta(meth)acrylate, tripentaerythritol hexa(meth)acrylate, tripentaerythritol penta(meth)acrylate, neopentyl hydroxybivalate glycol di(meth)acrylate, di(meth)acrylate of F-caprolactone adduct of neopentyl hydroxybivalate, trimethylolpropane tri(meth)acrylate, trimethylolpropane polyethoxytri(meth)acrylate, and ditrimethylolpropane tetra(meth)acrylate.

Among the above, from the viewpoint of imparting appropriate toughness to the cured product, a polyfunctional (meth)acrylate monomer having an alkylene glycol skeleton, such as polyethylene glycol di(meth)acrylate, polypropylene glycol di(meth)acrylate, and polytetramethylene glycol di(meth)acrylate, is more preferable.

From the viewpoint of imparting appropriate flexibility to the cured product, a molecular weight of the polyfunctional (meth)acrylate monomer is preferably 200 or more, more preferably 300 or more, still more preferably 400 or more, and particularly preferably 500 or more. The upper limit of the molecular weight of the polyfunctional (meth)acrylic monomer is usually 3,000 or less, preferably 2,000 or less.

Examples of the polyfunctional (meth)acrylic oligomer include polyester (meth)acrylate, epoxy (meth)acrylate, urethane (meth)acrylate, and polyether (meth)acrylate.

Among the above, from the viewpoint of imparting appropriate toughness to the cured product, urethane (meth)acrylate is preferable.

The above-described polyfunctional urethane (meth)acrylate can be obtained by reacting a polyol, a polyisocyanate, and a hydroxyl group-containing (meth)acrylate with each other.

The above-described polyol may be any compound having two or more hydroxyl groups, and examples thereof include an aliphatic polyol, an alicyclic polyol, a polyether polyol, a polyester polyol, a polycarbonate polyol, a polyolefin polyol, a polybutadiene polyol, a polyisoprene polyol, a (meth)acrylic polyol, and a polysiloxane polyol.

Among the above, from the viewpoint of obtaining excellent flexibility, a polyether polyol is preferable; and among these, polyethylene glycol, polypropylene glycol, or polytetramethylene glycol is preferable.

The above-described polyol compound can be used alone or in combination of two or more kinds thereof.

The above-described polyisocyanate may be any compound having two or more isocyanate groups, and examples thereof include aromatic polyisocyanates such as tolylene diisocyanate, diphenylmethane diisocyanate, polyphenylmethane polyisocyanate, modified diphenylmethane diisocyanate, xylylene diisocyanate, tetramethylxylylene diisocyanate, phenylene diisocyanate, and naphthalene diisocyanate; aliphatic polyisocyanates such as pentamethylene diisocyanate, hexamethylene diisocyanate, trimethylhexamethylene diisocyanate, lysine diisocyanate, and lysine triisocyanate; alicyclic polyisocyanates such as hydrogenated diphenylmethane diisocyanate, hydrogenated xylylene diisocyanate, isophorone diisocyanate, and norbornene diisocyanate; and trimeric compounds or polymeric compounds of these polyisocyanates, allophanate-type polyisocyanate, biuret-type polyisocyanate, and water-dispersed polyisocyanate.

Among the above, from the viewpoint of stability during the urethanization reaction, a diisocyanate is preferable; in particular, an aliphatic diisocyanate such as pentamethylene diisocyanate, hexamethylene diisocyanate, trimethylhexamethylene diisocyanate, and lysine diisocyanate, or an alicyclic diisocyanate such as hydrogenated diphenylmethane diisocyanate, hydrogenated xylylene diisocyanate, isophorone diisocyanate, norbornene diisocyanate, and 1,3-bis(isocyanatomethyl)cyclohexane is preferably used.

The above-described isocyanate can be used alone or in combination of two or more kinds thereof.

The above-described hydroxyl group-containing (meth)acrylate is a compound having a hydroxyl group and a (meth)acryloyl group. The number of hydroxyl groups is preferably 1 to 5 and particularly preferably 1.

Examples of the above-described hydroxyl group-containing (meth)acrylate include hydroxyl group-containing (meth)acrylates containing one (meth)acryloyl group, such as 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethyl acryloyloxy phosphate, 2-(meth)acryloyloxyethyl-2-hydroxypropyl phthalate, caprolactone-modified 2-hydroxyethyl (meth)acrylate, dipropylene glycol mono(meth)acrylate, fatty acid-modified glycidyl (meth)acrylate, polyethylene glycol mono(meth)acrylate, polypropylene glycol mono(meth)acrylate, 2-hydroxy-3-(meth)acryloyloxypropyl (meth)acrylate, dimethylolcyclohexyl mono(meth)acrylate, and hydroxycaprolactone (meth)acrylate; hydroxyl group-containing (meth)acrylates containing two (meth)acryloyl groups, such as glycol di(meth)acrylate and 2-hydroxy-3-acryloyloxypropyl methacrylate; and hydroxyl group-containing (meth)acrylates containing three or more (meth)acryloyl groups, such as pentaerythritol tri(meth)acrylate, caprolactone-modified pentaerythritol tri(meth)acrylate, ethylene oxide-modified pentaerythritol tri(meth)acrylate, dipentaerythritol penta(meth)acrylate, caprolactone-modified dipentaerythritol penta(meth)acrylate, and ethylene oxide-modified dipentaerythritol penta(meth)acrylate. These can be used alone or in combination of two or more kinds thereof.

Among the above, a hydroxyl group-containing (meth)acrylate containing two or less (meth)acryloyl groups is preferable; and among these, a compound containing one (meth)acryloyl group, such as hydroxyethyl (meth)acrylate, hydroxypropyl (meth)acrylate, hydroxybutyl (meth)acrylate, dimethylolcyclohexyl mono(meth)acrylate, and hydroxycaprolactone (meth)acrylate, is preferable, and hydroxyethyl (meth)acrylate, hydroxypropyl (meth)acrylate, or hydroxybutyl (meth)acrylate is more preferable.

From the viewpoint that a cured product having high toughness is obtained, in other words, from the viewpoint that a cured product with appropriate flexibility is obtained when the adhesive composition is cured, a molecular weight of the polyfunctional (meth)acrylic oligomer is preferably 3,000 or more, more preferably 5,000 or more, still more preferably 8,000 or more, and particularly preferably 10,000 or more. The upper limit of the molecular weight is usually 100,000 or less, preferably 50,000 or less.

The monofunctional (meth)acrylate is a compound having one (meth)acryloyl group. When containing the monofunctional (meth)acrylate, a molecular weight between crosslinking points of the cured product can be increased, which increases a degree of freedom of movement of the molecular chain and makes it easy to obtain a cured product having excellent stress relaxation properties.

Examples of the monofunctional (meth)acrylate monomer include those described as monomers forming the (meth)acrylic copolymer (A).

Examples of the monofunctional (meth)acrylate oligomer include polyester (meth)acrylate, epoxy (meth)acrylate, urethane (meth)acrylate, and polyether (meth)acrylate. Among the above, from the viewpoint of flexibility, a (meth)acrylate oligomer having an alkylene glycol skeleton is preferable.

Examples of the above-described (meth)acrylate oligomer having an alkylene glycol skeleton include a monofunctional (meth)acrylate oligomer represented by Formula (III).

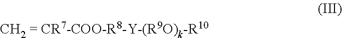

In Formula (III), R⁷ represents a hydrogen atom or a methyl group.

R⁸ represents an alkenyl group having 1 to 20 carbon atoms, and may have an ether bond or a cyclic structure in the chain.

Y represents a bonding group selected from any of a urethane bond, an ester bond, an ether bond, a carbonate bond, an amide bond, or a urea bond. From the viewpoint of imparting appropriate toughness to the cured product, Y is preferably a urethane bond, an amide bond, or a urea bond, and particularly preferably a urethane bond.

R⁹ represents an alkylene group which is an ethylene group or a propylene group. Therefore, (R⁹O)ₖ can be represented by [(C₂H₄O)ᵣ(C₃H₆O)ₛ]. r is 0 or an integer of 1 or more, s is 0 or an integer of 1 or more, and r+s=k. In [(C₂H₄O)ᵣ(C₃H₆O)ₛ], when the oxyethylene structure (C₂H₄O) and the oxypropylene structure (C₃H₆O) are present at the same time, a combination thereof may be a random type or a block type.

k represents an integer of 1 to 500 which is the number of repeating units of (R⁹O), that is, r+s, which is the total number of repeating units of (C₂H₄O)ᵣ and (C₃H₆O)ₛ.

R¹⁰ represents an alkyl group having 1 to 20 carbon atoms, and may have an ether bond or a cyclic structure in the chain.

From the viewpoint of reducing a storage shear modulus at a low temperature while maintaining high restoring properties during bending, a glass transition temperature of a polymerized product when homopolymerization, that is, a polymerized product obtained by polymerizing only the photocurable compound (B), is preferably −20° C. or lower, more preferably −25° C. or lower, still more preferably −30° C. or lower, and particularly preferably −40° C. or lower. On the other hand, from the viewpoint of shape stability, bleeding, and the like, the glass transition temperature of the polymerized product when homopolymerization is preferably −80° C. or higher, more preferably −75° C. or higher, still more preferably −70° C. or higher, and particularly preferably −65° C. or higher. Specifically, the glass transition temperature is preferably −80° C. or higher and −20° C. or lower, more preferably −75° C. or higher and −25° C. or lower, still more preferably −70° C. or higher and −30° C. or lower, and particularly preferably −65° C. or higher and −40° C.

From the viewpoint of reducing a storage shear modulus at a low temperature while maintaining high restoring properties in bending, a weight-average molecular weight (Mw) of the monofunctional (meth)acrylate oligomer is preferably 30,000 or less, more preferably 28,000 or less, and still more preferably 25,000 or less. On the other hand, from the viewpoint of preventing a decrease in adhesiveness, the lower limit value thereof is preferably 3,000 or more, more preferably 4,000 or more, and still more preferably 5,000 or more. Specifically, the weight-average molecular weight of the monofunctional (meth)acrylate oligomer is preferably 3,000 or more and 30,000 or less, more preferably 4,000 or more and 28,000 or less, and still more preferably 5,000 or more and 25,000 or less.

The weight-average molecular weight of the monofunctional (meth)acrylate oligomer is a value in terms of standard polystyrene, which is measured by gel permeation chromatography (GPC).

From the viewpoint of easily imparting excellent shape stability and restoring properties, a contained amount of the photocurable compound (B) in the adhesive composition forming the adhesive sheet is preferably 0.1 parts by mass or more, more preferably 0.5 parts by mass or more, still more preferably 1.0 part by mass or more, and particularly preferably 1.2 parts by mass or more with respect to 100 parts by mass of the (meth)acrylic copolymer (A). On the other hand, from the viewpoint of ensuring the flexibility and the adhesiveness of the adhesive sheet, the contained amount of the photocurable compound (B) is preferably 50 parts by mass or less, more preferably 30 parts by mass or less, still more preferably 25 parts by mass or less, particularly preferably 10 parts by mass or less, and most preferably 5 parts by mass or less with respect to 100 parts by mass of the (meth)acrylic copolymer (A). The above-described lower limit and upper limit of the contained amount of the photocurable compound (B) can be arbitrarily combined. Specifically, the above-described contained amount of the photocurable compound (B) is preferably 0.1 parts by mass or more and 50 parts by mass or less, more preferably 0.5 parts by mass or more and 30 parts by mass or less, still more preferably 1.0 parts by mass or more and 25 parts by mass or less, particularly preferably 1.2 parts by mass or more and 10 parts by mass or less, and most preferably 1.0 part by mass or more and 5 parts by mass or less with respect to 100 parts by mass of the (meth)acrylic copolymer (A).

### [Photoinitiator (C)]

The adhesive composition forming the adhesive sheet may contain, as necessary, a photoinitiator (C) other than the (meth)acrylic copolymer (A). When the adhesive composition contains the photoinitiator (C), the curing efficiency by the active energy rays can be further improved.

The photoinitiator (C) is a compound which generates active radical species when irradiated with light such as ultraviolet rays and visible light, more specifically, light having a wavelength of 200 nm to 780 nm.

The photoinitiator (C) can be appropriately selected from known photoinitiators, and examples thereof include a cleavage-type photoinitiator and a hydrogen abstraction-type photoinitiator.

Examples of the cleavage-type photoinitiator include 2,2-dimethoxy-1,2-diphenylethan-1-one, 1-hydroxycyclohexylphenylketone, 2-hydroxy-2-methyl-1-phenyl-propan-1-one, 1-[4-(2-hydroxyethoxy)phenyl]-2-hydroxy-2-methyl-1-propan-1-one, 2-hydroxy-1-[4-{4-(2-hydroxy-2-methyl-propionyl)benzyl}phenyl]-2-methyl-propan-1-one, oligo(2-hydroxy-2-methyl-1-(4-(1-methylvinyl)phenyl)propanone), 2-benzyl-2-dimethylamino-1-(4-morpholinophenyl)butan-1-one, 2-methyl-1-[4-(methylthio)phenyl]-2-morpholinopropan-1-one, 2-(dimethylamino)-2-[(4-methylphenyl)methyl]-1-[4-(4-morpholinyl)phenyl]-1-butanone, bis(2,4,6-trimethylbenzoyl)-phenylphosphine oxide, 2,4,6-trimethylbenzoyldiphenylphosphine oxide, (2,4,6-trimethylbenzoyl)ethoxyphenylphosphine oxide, bis(2,6-dimethoxybenzoyl)2,4,4-trimethylpentylphosphine oxide, and a derivative thereof.

Examples of the hydrogen abstraction-type photoinitiator include intermolecular hydrogen abstraction-type photoinitiators such as benzophenone, 4-methyl-benzophenone, 2,4,6-trimethylbenzophenone, 4-phenylbenzophenone, 3,3′-dimethyl-4-methoxybenzophenone, 4-(meth)acryloyloxybenzophenone, methyl 2-benzoylbenzoate, 4-[(4-methylphenyl)thio]benzophenone, 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, and 4-methacryloyloxyethoxy-4′-bromobenzophenone; and intramolecular hydrogen abstraction-type photoinitiators such as methyl benzoylformate, oxyphenylacetic acid-2-(2-oxo-2-phenylacetoxy-ethoxy)ethyl ester, and oxyphenylacetic acid-2-(2-hydroxy-ethoxy)ethyl ester.

As the cleavage-type photoinitiator and the hydrogen abstraction-type photoinitiator, any one may be used, or both may be used in a mixed form. Furthermore, each of the cleavage-type photoinitiator and the hydrogen abstraction-type photoinitiator may be used alone or in combination of two or more kinds thereof.

The photoinitiator (C) preferably includes the hydrogen abstraction-type photoinitiator. When the photoinitiator (C) includes the hydrogen abstraction-type photoinitiator, a hydrogen abstraction reaction also occurs from the (meth)acrylic copolymer (A), and thus a crosslinked structure having a large number of crosslinking points can be formed. In addition, among the hydrogen abstraction-type photoinitiators, the intramolecular hydrogen abstraction-type photoinitiator is preferable because it can be a radical generation site not only of the hydrogen donor in the system but also of itself.

When the adhesive composition contains the photoinitiator (C), from the viewpoint of improving the curing efficiency and the viewpoint of the restoring properties and shape stability of the cured product, a contained amount of the photoinitiator (C) in the adhesive composition forming the adhesive sheet is preferably 0.1 parts by mass or more, more preferably 0.3 parts by mass or more, still more preferably 0.5 parts by mass or more, and particularly preferably 1 part by mass or more with respect to 100 parts by mass of the (meth)acrylic copolymer (A). On the other hand, from the viewpoint of compatibility and suppression of the bleed-out, the contained amount of the photoinitiator (C) is preferably 10 parts by mass or less, more preferably 5 parts by mass or less, still more preferably 3 parts by mass or less, and particularly preferably 2 parts by mass or less with respect to 100 parts by mass of the copolymer (A). The lower limit and upper limit of the above-described contained amount of the photoinitiator (C) can be arbitrarily combined. Specifically, the contained amount of the photoinitiator (C) is preferably 0.1 parts by mass or more and 10 parts by mass or less, more preferably 0.3 parts by mass or more and 5 parts by mass or less, still more preferably 0.5 parts by mass or more and 3 parts by mass or less, and particularly preferably 1 part by mass or more and 2 parts by mass or less with respect to 100 parts by mass of the (meth)acrylic copolymer (A).

### [Other Components]

The adhesive composition forming the adhesive sheet may further contain other components in addition to the (meth)acrylic copolymer (A), the photocurable compound (B), and the photoinitiator (C), as necessary. Examples of the other components include various additives such as a silane coupling agent, a viscosity imparting resin, a plasticizer, an antioxidant, a light stabilizer, a metal inactivator, an anti-aging agent, a moisture absorbent, a polymerization inhibitor, an ultraviolet absorber, a rust inhibitor, inorganic particles, a sensitizer, and a pigment. It is preferable that a contained amount of the additive is typically set to not adversely affect the curing of the adhesive sheet or to not adversely affect the physical characteristics of the adhesive sheet.

### [Method for Manufacturing Adhesive Sheet]

A method for manufacturing the adhesive sheet according to the embodiment is not particularly limited.

For example, the adhesive sheet according to the embodiment can be obtained by mixing predetermined amounts of the (meth)acrylic copolymer (A) with the photocurable compound (B), the photoinitiator (C), the additive, and the like, used as necessary to prepare the adhesive composition, molding the adhesive composition into a sheet shape, curing the adhesive composition by a radical reaction, and optionally processing the adhesive composition. Alternatively, the adhesive sheet according to the embodiment may be formed by preparing the adhesive composition as described above, coating an image display device component with the adhesive composition, and curing the adhesive composition.

As a method of mixing each component, a method using a single-screw extruder, a twin-screw extruder, a planetary mixer, a twin-screw mixer, or a pressure kneader is an exemplary example.

As a method of molding the adhesive composition into a sheet shape, for example, a wet lamination method, a dry lamination method, a cast extrusion method using a T-die, an extrusion lamination method, a calendering or inflation method, an injection molding method, and a liquid injection curing method are exemplary examples.

The adhesive sheet according to the embodiment may be formed by dissolving the adhesive composition in an appropriate solvent, applying the adhesive composition using various coating methods, and irradiating the adhesive composition with active energy rays.

The adhesive composition can be cured by irradiation with active energy rays. For example, the adhesive sheet according to the embodiment can be manufactured by irradiating, with active energy rays, a molded body of the adhesive composition, for example, a molded body obtained by molding the adhesive composition into a sheet body. In addition to the irradiation with active energy rays, the adhesive composition can be further cured by heating.

The irradiation energy, the irradiation time, the irradiation method, and the like of the active energy ray are not particularly limited, and it is sufficient that a crosslinked structure can be formed by activating the photoinitiator to generate a radical in the constitutional unit derived from the monomer M.

Examples of the active energy ray to be radiated include ionizing radiation such as α-rays, β-rays, γ-rays, neutron beams, electron beams, ultraviolet rays, and visible light. Among the above, from the viewpoint of suppressing damage to the image display device component and controlling the reaction, ultraviolet rays are preferable. As a light source for radiating the active energy ray, for example, a high-pressure mercury lamp, a metal halide lamp, a xenon lamp, a halogen lamp, an LED lamp, and a fluorescent lamp are exemplary examples.

From the viewpoint of high-efficiency curing, the irradiation amount of the active energy ray is preferably 6,000 mJ/cm² or less, more preferably 5,000 mJ/cm² or less, still more preferably 4,000 mJ/cm² or less, and particularly preferably 3,000 mJ/cm² or less. From the viewpoint of sufficient curing, the irradiation amount of the active energy ray is preferably 100 mJ/cm² or more, more preferably 250 mJ/cm² or more, still more preferably 500 mJ/cm² or more, and particularly preferably 1,000 mJ/cm² or more. The above-described lower limit and upper limit of the irradiation amount of active energy ray can be arbitrarily combined.

### [Physical Properties of Adhesive Sheet]

Hereinafter, physical properties of the adhesive sheet according to the example of the embodiment will be described.

The adhesive sheet according to one example of the embodiment satisfies the following requirement (1).

(1) A storage modulus (G′(−20° C.)) at −20° C., which is obtained by a dynamic viscoelasticity measurement in a shear mode at a frequency of 1 Hz, is 10 kPa or more and 1,000 kPa or less.

The adhesive sheet satisfying the requirement (1) is flexible even at a low temperature, and has excellent flexibility. For example, even when a folding operation is repeatedly performed at a low temperature of −20° C., cracks and breakage are less likely to occur in a member which is an adherend of the adhesive sheet.

From the viewpoint of shape holding power of the adhesive sheet when not bonded, the G′(−20° C.) in the requirement (1) is preferably 30 kPa or more, more preferably 50 kPa or more, and still more preferably 100 kPa or more. On the other hand, from the viewpoint of flexibility of the adhesive sheet in a low-temperature environment, the G′(−20° C.) in the requirement (1) is preferably 800 kPa or less, more preferably 600 kPa or less, still more preferably 400 kPa or less, and particularly preferably 300 kPa or less. The above-described lower limit and upper limit of the G′(−20° C.) in the requirement (1) can be arbitrarily combined. Specifically, the G′(−20° C.) is preferably 30 kPa or more and 800 kPa or less, more preferably 50 kPa or more and 600 kPa or less, still more preferably 100 kPa or more and 400 kPa or less, and particularly preferably 100 kPa or more and 300 kPa or less.

In order to accurately measure the storage shear modulus G′, it is necessary to avoid fluctuations in measurement results due to influence of a measurement jig by insufficient thickness of the adhesive sheet. The requirement (1) is a value measured after adjusting the thickness to a range of 0.7 to 1.0 mm, and thus the storage shear modulus G′ can be accurately measured without being affected by the measurement jig.

The above-described “adjusting the thickness to a range of 0.7 to 1.0 mm” means that, when the thickness of the adhesive sheet used as a measurement sample is not within this range, the thickness of the measurement sample is adjusted to within this range by stacking several sheets. The same applies to other tests when the thickness of the measurement sample is defined.

The measurement of the G′ (−20° C.) in the requirement (1) is carried out as follows, for example.

After repeatedly laminating the adhesive sheet to adjust the thickness thereof to 0.7 to 1.0 mm (for example, 0.8 mm), a circular sample having a diameter of 8 mm is punched out. A dynamic viscoelasticity measurement of the obtained sample is performed using a rheometer under the conditions of a measurement jig of an 8 mm-diameter parallel plate, a frequency of 1 Hz, a measurement temperature of −50° C. to 150° C., and a temperature rising rate of 5° C./min, and a value of a storage shear modulus G′ at −20° C. is read.

Examples of a method of adjusting G′(−20° C.) of the requirement (1) in the adhesive sheet to the above-described range include a method of adjusting the formulation or molecular weight of the (meth)acrylic copolymer (A) and the kind or addition amount of the photocurable compound (B). However, the method is not limited to these methods.

The adhesive sheet according to one example of the embodiment further satisfies the following requirement (2).

(2) A maximum strain value (γₘₐₓ) when a stress of 2 kPa is applied at 60° C. for 600 seconds is less than 80%.

The adhesive sheet satisfying the requirement (2) has excellent shape stability.

The adhesive sheet used for the flexible image display device is particularly required to have flexibility, but shape stability of the adhesive sheet in the related art tends to deteriorate as the flexibility increases. However, in the adhesive sheet, which satisfies the requirement (2) together with the requirement (1), an adhesive sheet which is flexible and has excellent shape stability can be obtained.

From the viewpoint of shape stability, the maximum strain value (γₘₐₓ) in the requirement (2) is preferably 75% or less, more preferably 70% or less, still more preferably 60% or less, particularly preferably 50% or less, and most preferably 40% or less.

On the other hand, the maximum strain value (γₘₐₓ) is usually 0% or more, but from the viewpoint of excellent unevenness followability when the surface of the adherend has unevenness, the maximum strain value (γₘₐₓ) in the requirement (2) is preferably 1% or more, more preferably 2% or more, and still more preferably 3% or more.

The upper limit and the lower limit of the maximum strain value (γₘₐₓ) in the requirement (2) can be arbitrarily combined. Specifically, the maximum strain value (γₘₐₓ) in the requirement (2) is preferably 1% or more and 75% or less, more preferably 2% or more and 70% or less, still more preferably 3% or more and 60% or less, particularly preferably 5% or more and 50% or less, and most preferably 8% or more and 40% or less.

The maximum strain value (γₘₐₓ) in the requirement (2) is, for example, measured as follows.

After repeatedly laminating the adhesive sheet to adjust the thickness thereof to 0.7 to 1.0 mm, a circular sample having a diameter of 8 mm is punched out. For the obtained sample, a strain value after applying a pressure of 2 kPa at 60° C. for 600 seconds using a rheometer is read as the maximum strain value (γₘₐₓ).

Examples of a method of adjusting the maximum strain value (γₘₐₓ) in the requirement (2) to the above-described range include a method of adjusting the formulation or molecular weight of the (meth)acrylic copolymer (A) and the kind or addition amount of the photocurable compound (B), and a method of controlling the amount of irradiation with active energy rays. However, the method is not limited to these methods.

It is preferable that the adhesive sheet according to one example of the embodiment further satisfies the following requirement (3).

(3) A storage shear modulus (G′(30° C.)) at 30° C., which is obtained by a dynamic viscoelasticity measurement in a shear mode at a frequency of 1 Hz, is 1,000 kPa or less.

The adhesive sheet satisfying the requirement (3) is flexible, and, for example, even when the surface of the adherend has unevenness, the adhesive sheet has excellent unevenness followability. From such a viewpoint, the G′(30° C.) in the requirement (3) is preferably 500 kPa or less, more preferably 200 kPa or less, still more preferably 100 kPa or less, particularly preferably 50 kPa or less, and most preferably 40 kPa or less. On the other hand, from the viewpoint of handleability and shape stability, the G′(30° C.) in the requirement (3) is preferably 1 kPa or more, more preferably 2 kPa or more, still more preferably 5 kPa or more, and particularly preferably 10 kPa or more. The above-described upper limit and lower limit of the G′(30° C.) in the requirement (3) can be arbitrarily combined. Specifically, the G′(30° C.) is preferably 1 kPa or more and 500 kPa or less, more preferably 2 kPa or more and 200 kPa or less, still more preferably 5 kPa or more and 100 kPa or less, particularly preferably 10 kPa or more and 50 kPa or less, and most preferably 15 kPa or more and 40 kPa or less.

It is preferable that the adhesive sheet according to one example of the embodiment further satisfies the following requirement (4).

(4) A storage shear modulus (G′(80° C.)) at 80° C., which is obtained by a dynamic viscoelasticity measurement in a shear mode at a frequency of 1 Hz, is 10 kPa or more.

The adhesive sheet satisfying the requirement (4) has excellent shape stability and durability at a high temperature. From such a viewpoint, the G′(80° C.) in the requirement (4) is preferably 20 kPa or more, more preferably 30 kPa or more, still more preferably 40 kPa or more, particularly preferably 50 kPa or more, and most preferably 60 kPa or more. On the other hand, from the viewpoint of adhesiveness and stress relaxation properties, the G′(80° C.) in the requirement (4) is preferably 500 kPa or less, more preferably 400 kPa or less, still more preferably 300 kPa or less, and particularly preferably 200 kPa or less. The above-described lower limit and upper limit of the G′(80° C.) in the requirement (4) can be arbitrarily combined. Specifically, the G′(80° C.) in the requirement (4) is preferably 20 kPa or more and 500 kPa or less, more preferably 30 kPa or more and 400 kPa or less, still more preferably 40 kPa or more and 300 kPa or less, particularly preferably 50 kPa or more and 200 kPa or less, and most preferably 60 kPa or more.

A method of measuring G′(30° C.) in the requirement (3) and a method of measuring G′(80° C.) in the requirement (4) are the same as the measurement of the G′(−20° C.) in the requirement (1), except that values of the storage shear modulus (G′) at 30° C. and 80° C. are read.

Examples of the method of adjusting the storage shear modulus G′ of the adhesive sheet within the above-described range include a method of adjusting the formulation or molecular weight of the (meth)acrylic copolymer (A), a method of adjusting the kind or addition amount of the photocurable compound (B) and the photoinitiator (C), and a method of adjusting the amount of irradiation with active energy rays. However, the method is not limited to these methods.

It is preferable that the adhesive sheet according to one example of the embodiment further satisfies the following requirement (5).

(5) A glass transition temperature (Tg) defined by a maximal value of Tan δ, which is obtained by a dynamic viscoelasticity measurement in a shear mode at a frequency of 1 Hz, is −20° C. or lower.

The adhesive sheet satisfying the requirement (5) has excellent flexibility.

From the viewpoint of obtaining excellent flexibility, Tg in the requirement (5) is preferably −25° C. or lower, more preferably −28° C. or lower, still more preferably −30° C. or lower, and particularly preferably −35° C. or lower. On the other hand, the lower limit thereof is usually −80° C. Specifically, Tg in the requirement (5) is preferably −80° C. or higher and −20° C. or lower, more preferably −80° C. or higher and −25° C. or lower, still more preferably −75° C. or higher and −28° C. or lower, particularly preferably −70° C. or higher and −30° C. or lower, and most preferably −65° C. or higher and −35° C. or lower.

The measurement of Tg in the requirement (5) is carried out as follows, for example.

After repeatedly laminating the adhesive sheet to adjust the thickness thereof to 0.7 to 1.0 mm (for example, 0.8 mm), a circular sample having a diameter of 8 mm is punched out. A dynamic viscoelasticity measurement of the obtained sample is performed using a rheometer under the conditions of a measurement jig of an 8 mm-diameter parallel plate, a frequency of 1 Hz, a measurement temperature of −50° C. to 150° C., and a temperature rising rate of 5° C./min, and a Tan 6 value can be determined by reading the temperature at which the Tan 6 value is maximized from the obtained dynamic viscoelasticity spectrum.

Examples of the method of adjusting Tg in the requirement (5) within the above-described range include a method of adjusting the formulation or molecular weight of the (meth)acrylic copolymer (A), a method of adjusting the kind or addition amount of the photocurable compound (B) and the photoinitiator (C), and a method of adjusting the amount of irradiation with active energy rays. However, the method is not limited to these methods.

It is preferable that the adhesive sheet according to one example of the embodiment further satisfies the following requirement (6).

(6) A restoration rate calculated by the following expression from the maximum strain value (γₘₐₓ) when the stress of 2 kPa is applied at 60° C. for 600 seconds and a residual strain value (γₘᵢₙ) after 600 seconds from a point of time when the stress is removed is 60% or more.

$$Restoration rate ( \% ) = [ ( {γ}_{max} - {γ}_{min} ) / {γ}_{max} ] \times 100$$

The adhesive sheet satisfying the requirement (6) has excellent restoring properties during folding.

From the viewpoint of obtaining an adhesive sheet having excellent restoring properties during folding, the restoration rate in the requirement (6) is preferably 70% or more, more preferably 80% or more, still more preferably 85% or more, particularly preferably 87% or more, and most preferably 90% or more. On the other hand, the upper limit thereof is usually 100%, but from the viewpoint of improving the adhesive force, the restoration rate in the requirement (6) is preferably 99% or less, and more preferably 98% or less. The above-described lower limit and upper limit of the restoration rate in the requirement (6) can be arbitrarily combined. Specifically, the restoration rate is preferably 60% or more and 100% or less, more preferably 70% or more and 99% or less, still more preferably 80% or more and 98% or less, even still more preferably 85% or more and 98% or less, particularly preferably 87% or more and 98% or less, and most preferably 90% or more and 98% or less.

For example, the measurement of the restoration rate in the requirement (6) is carried out as follows.

After repeatedly laminating the adhesive sheet to adjust the thickness thereof to 0.7 to 1.0 mm, a circular sample having a diameter of 8 mm is punched out. For the obtained sample, a strain (γₘₐₓ) after applying a pressure of 2 kPa at 60° C. for 600 seconds and a strain (γₘᵢₙ) after the stress is released and 600 seconds have elapsed are measured using a rheometer. The obtained values are substituted into the following expression to calculate the restoration rate.

$$Restoration rate ( \% ) = [ ( {γ}_{max} - {γ}_{min} ) / {γ}_{max} ] \times 100$$

Examples of the method of adjusting the restoration rate in the requirement (6) within the above-described range include a method of adjusting the formulation or molecular weight of the (meth)acrylic copolymer (A), a method of adjusting the kind or addition amount of the photocurable compound (B) and the photoinitiator (C), and a method of adjusting the amount of irradiation with active energy rays. However, the method is not limited to these methods.

It is preferable that the adhesive sheet according to one example of the embodiment further satisfies the following requirement (7).

(7) A gel fraction is 30% or more.

The adhesive sheet satisfying the requirement (7) has excellent cohesive force. From the viewpoint of improving the cohesive force, the gel fraction in the requirement (7) is preferably 35% or more, more preferably 40% or more, and still more preferably 45% or more. On the other hand, from the viewpoint of obtaining the adhesive force, the gel fraction in the requirement (7) is preferably 98% or less, more preferably 95% or less, and still more preferably 92% or less. The above-described lower limit and upper limit of the gel fraction in the requirement (7) can be arbitrarily combined. Specifically, the gel fraction is preferably 30% or more and 98% or less, more preferably 35% or more and 98% or less, still more preferably 40% or more and 95% or less, and particularly preferably 45% or more and 92% or less.

For example, the measurement of the gel fraction in the requirement (7) is carried out as follows.

A pre-weighed adhesive sheet is wrapped in an SUS wire mesh of 150 mesh, and immersed in ethyl acetate at 23° C. for 24 hours. Thereafter, the adhesive sheet is dried at 70° C. for 4.5 hours, the mass of the adhesive before and after the immersion in ethyl acetate is measured, and the difference between the masses is defined as the mass (mass after immersion) of the adhesive remaining in the wire mesh in an insoluble state. The percentage of the mass of the insoluble adhesive agent remaining in the wire mesh (mass after immersion) with respect to the mass of the adhesive before immersion in ethyl acetate (mass before immersion) is calculated as the gel fraction (%) in the requirement (6).

Examples of a method of adjusting the gel fraction in the requirement (7) to the above-described range include a method of adjusting the formulation or molecular weight of the (meth)acrylic copolymer (A) and the kind or addition amount of the photocurable compound (B), and a method of controlling the amount of irradiation with active energy rays. However, the method is not limited to these methods.

It is preferable that the adhesive sheet according to the embodiment further satisfies the following requirement (8).

(8) When the adhesive sheet is bonded to a polyester film, an adhesive force to a surface of the polyester film at 23° C., 50% RH, a peeling angle of 180°, and a peeling rate of 300 mm/min is 0.5 N/cm or more.

Since the adhesive sheet satisfying the requirement (8) has excellent adhesiveness and delamination is less likely to occur even when a laminate bonded to an adherend such as an image display device component is folded, durability is excellent.

From the viewpoint of adhesiveness of the adhesive sheet, the adhesive force in the requirement (8) is preferably 1 N/cm or more, more preferably 2 N/cm or more, still more preferably 3 N/cm or more, and particularly preferably 4 N/cm or more. The upper limit of the adhesive force in the requirement (8) is not particularly limited, and can be, for example, 20 N/cm or less. Specifically, the adhesive force in the requirement (8) is preferably 1 N/cm or more and 20 N/cm or less, more preferably 2 N/cm or more and 20 N/cm or less, still more preferably 3 N/cm or more and 18 N/cm or less, and particularly preferably 4 N/cm or more and 18 N/cm or less.

The measurement of the adhesive force in the requirement (8) is carried out as follows, for example.

A polyester film is back-coated as a backing film on one surface of the adhesive sheet and cut into a strip shape having a width of 10 mm and a length of 150 mm to obtain a test piece. The above-described test piece is adhered to a polyester film, which has been bonded to soda-lime glass in advance, and subjected to an autoclave treatment (60° C., gauge pressure of 0.2 MPa, and 20 minutes) to obtain a measurement sample of adhesive force. For the obtained measurement sample of adhesive force, under the conditions of 23° C., 50% RH, a peeling angle of 180°, and a peeling rate of 300 mm/min, the adhesive sheet is peeled off together with the backing film from the polyester film bonded to the soda-lime glass, and a tensile strength (N/cm) is measured with a load cell to obtain the adhesive force.

It is preferable that the adhesive sheet according to the embodiment further satisfies the following requirement (9).

(9) When the adhesive sheet is bonded to a polyester film, an adhesive force to a surface of the polyester film at 60° C., 10% RH, a peeling angle of 180°, and a peeling rate of 300 mm/min is 0.1 N/cm or more.

The adhesive sheet satisfying the requirement (9) has excellent durability at a high temperature.

From the viewpoint of durability of the adhesive sheet, the adhesive force in the requirement (9) is preferably 0.2 N/cm or more, more preferably 0.3 N/cm or more, still more preferably 0.4 N/cm or more, and particularly preferably 0.5 N/cm or more. The upper limit of the adhesive force in the requirement (9) is not particularly limited, and can be, for example, 20 N/cm or less. Specifically, the adhesive force in the requirement (9) is preferably 0.2 N/cm or more and 20 N/cm or less, more preferably 0.3 N/cm or more and 20 N/cm or less, still more preferably 0.4 N/cm or more and 18 N/cm or less, and particularly preferably 0.5 N/cm or more and 18 N/cm or less.

The measurement of the adhesive force in the requirement (9) is the same as the measurement of the adhesive force in the requirement (8), except that the test environment is set to 60° C. and 10% RH.

Examples of the method of adjusting the adhesive force within the above-described range include a method of adjusting the formulation or molecular weight of the (meth)acrylic copolymer (A), a method of adjusting the kind or addition amount of the photocurable compound (B) and the photoinitiator (C), and a method of adjusting the amount of irradiation with active energy rays. However, the method is not limited to these methods.

It is preferable that the adhesive sheet according to the embodiment further satisfies the following requirement (10).

(10) A total light transmittance is 80% or more.

The adhesive sheet satisfying the requirement (10) has excellent transparency and is useful for applications requiring transparency, such as an image display device.

The total light transmittance in the requirement (10) is preferably 85% or more, and more preferably 90% or more. It is preferable that the total light transmittance in the requirement (10) is higher, and the upper limit thereof is not particularly limited. Specifically, the total light transmittance in the requirement (10) is preferably 85% or more and 100% or less, and more preferably 90% or more and 100% or less.

The measurement of the total light transmittance in the requirement (10) is carried out in conformity with the standard of JIS-K 7361-1 (ISO-13468-1).

It is preferable that the adhesive sheet according to the embodiment further satisfies the following requirement (11).

(11) A haze is 5% or less.

The adhesive sheet satisfying the requirement (11) has excellent transparency, and is useful for applications requiring transparency, such as an image display device.

The haze in the requirement (11) is preferably 4% or less, more preferably 2% or less, and still more preferably 1% or less. It is preferable that the haze in the requirement (11) is lower, and the lower limit thereof is not particularly limited. Specifically, the haze in the requirement (11) is preferably 0% or more and 4% or less, more preferably 0% or more and 2% or less, and still more preferably 0% or more and 1% or less.

The measurement of the haze in the requirement (11) is carried out in conformity with the standard of JIS-K 7136 (ISO-14782).

As a method of adjusting the total light transmittance in the requirement (10) and the haze in the requirement (11), for example, the formulation of the (meth)acrylic acid ester copolymer may be adjusted, a colorless photoinitiator may be used, or a colorant may not be contained. In addition, coloring due to heating or aging deterioration may be suppressed by using an antioxidant. However, the method is not limited to these methods.

The adhesive sheet according to the embodiment may have a single-layer configuration or a multi-layer configuration. When a multi-layer configuration, each of the plurality of layers is formed of the adhesive composition containing the (meth)acrylic copolymer (A).

From the viewpoint that handleability is favorable and excellent unevenness followability is easily obtained, the thickness of the adhesive sheet according to the embodiment is preferably 5 μm or more, more preferably 10 μm or more, still more preferably 15 μm or more, and particularly preferably 20 μm or more. From the viewpoint that it is easy to relieve stress when folding or bending, and it is easy to make a flexible image display device using the adhesive sheet thinner, the thickness of the adhesive sheet according to the embodiment is preferably 100 μm or less, more preferably 80 μm or less, still more preferably 70 μm or less, and particularly preferably 60 μm or less. The above-described lower limit and upper limit of the thickness of the adhesive sheet can be arbitrarily combined. Specifically, the thickness of the adhesive sheet is preferably 5 μm or more and 100 μm or less, more preferably 10 μm or more and 80 μm or less, still more preferably 15 μm or more and 70 μm or less, and particularly preferably 20 μm or more and 60 μm or less.

<Adhesive Sheet with Mold Release Film>

Another embodiment of the present invention relates to an adhesive sheet with a mold release film.

In the adhesive sheet according to the embodiment, it is preferable that a mold release film is laminated on at least one surface of the adhesive sheet before bonding, and it is more preferable that mold release films are laminated on both surfaces thereof.

When the mold release film is provided on both surfaces of the adhesive sheet, it is preferable to adopt a laminate configuration in which a lightly peeling film having a relatively low peeling force and a heavily peeling film having a relatively high peeling force are laminated. When the adhesive sheet with a mold release film, having release films on both surfaces, is used, first, one release film (lightly peeling film) is peeled off to expose one surface of the adhesive sheet and the adhesive sheet is bonded to an image display device component (referred to as a first member), and then the other release film (heavily peeling film) is peeled off to bond the other surface of the exposed adhesive sheet to an image display device component (referred to as a second member).

Examples of the mold release film include a polyester film, a polyolefin film, a polycarbonate film, a polystyrene film, an acrylic film, a triacetyl cellulose film, and a fluororesin film. Among the above, a polyester film or a polyolefin film is preferable, and a polyester film is more preferable.

In addition, since the film is easily peeled off the adhesive sheet after irradiation with active energy rays, the mold release film is preferably a film having a peeling force of 0.1 N/cm or less measured under conditions of a peeling angle of 180° and a peeling rate of 300 mm/min.

From the viewpoint of processability and handleability, a thickness of the mold release film is preferably 25 μm or more and 500 μm or less, more preferably 38 μm or more and 250 μm or less, and still more preferably 50 μm or more and 200 μm or less. The above-described lower limit and upper limit of the thickness of the mold release film can be arbitrarily combined.

### <Laminate for Image Display Device>

Another embodiment of the present invention relates to a laminate for an image display device.

In the laminate for an image display device according to the embodiment, two image display device components are laminated through the adhesive sheet according to the embodiment of the present invention.

Since the adhesive sheet according to the embodiment of the present invention has excellent flexibility and thus has excellent unevenness followability, the adhesive sheet is deformed by following the step on the surface of the image display device component, and two image display device components can be bonded together while absorbing the step.

Examples of the image display device component constituting the present laminate for an image display device include a flat panel image display device component and a flexible image display device component. Examples of such an image display device component include a liquid crystal display, a flexible display such as an organic electroluminescence (EL) display, a cover lens (cover film), a polarizing plate, a polarizer, a phase difference film, a barrier film, a viewing angle compensation film, a brightness improvement film, a contrast improvement film, a diffusion film, a semi-transmissive reflective film, an electrode film, a transparent conductive film, a metal mesh film, a touch sensor film, a light emitting element, a PSA, a color filter, and a flexible printed circuit board. Any one or two of these members can be used in combination. Examples of the combination include a combination of a flexible display and other image display device components, and a combination of a cover lens and other image display device components.

A material of the image display device component is not particularly limited. Examples thereof include resin sheets having, as a main component, a resin such as a urethane resin, a cycloolefin resin, a triacetyl cellulose resin, a (meth)acrylate resin, an epoxy resin, a polyimide resin, and a polyester resin; thin film glass; and metals.

The flexible image display device component means a member which is a bendable member and used for an image display device having a curved surface shape, or a member which is repeatedly bendable. In particular, it is preferable that the flexible image display device component is a member which can be fixed to a curved shape having a curvature radius of 25 mm or more, and particularly preferably a member which can withstand a bending action with a curvature radius of less than 25 mm, more preferably a curvature radius of less than 3 mm.

As a material of such a member, a resin sheet containing, as a main component, at least one resin selected from the group consisting of a urethane resin, a cycloolefin resin, a triacetyl cellulose resin, a (meth)acrylate resin, an epoxy resin, a polyimide resin, and a polyester resin is preferable. The resin is preferably at least one selected from the group consisting of a polyimide resin, a polyester resin, and a cycloolefin resin, and among these, a polyester resin; in particular, a polyethylene naphthalate (PEN), a polybutylene terephthalate (PBT), or a polyethylene terephthalate (PET) resin is preferable.

Here, the “main component” means a component having the highest mass ratio among components constituting the resin sheet. A contained amount of the main component is preferably 50% by mass or more, more preferably 55% by mass or more, and still more preferably 60% by mass or more with respect to the mass of the resin sheet.

As described above, the image display device component may have a step on the surface. For example, various unevenness may be present on a contact surface of the image display device component with the adhesive sheet due to wiring, printing, pattern development, surface treatment, embossing, or the like.

A height difference of the step of the image display device component is preferably 2 μm or more, more preferably 3 μm or more, and still more preferably 4 μm or more, and is preferably 10 μm or less, more preferably 8 μm or less, still more preferably 7 μm or less, and particularly preferably 6 μm or less. The above-described lower limit and upper limit of the height difference of the step can be arbitrarily combined. Specifically, the above-described height difference is preferably 2 μm or more and 8 μm or less, more preferably 3 μm or more and 7 μm or less, and still more preferably 4 μm or more and 6 μm or less.

The step of the image display device component on the contact surface with the adhesive sheet may be, for example, unevenness provided with a height difference of 2 to m and an interval of 10 mm or less.

From the viewpoint that the handleability is favorable, a thickness of the laminate for an image display device according to the embodiment is preferably 0.02 mm or more, more preferably 0.03 mm or more, and still more preferably 0.05 mm or more. From the viewpoint that the laminate can be made thinner, the thickness of the laminate for an image display device according to the embodiment is preferably 1.0 mm or less, more preferably 0.7 mm or less, and still more preferably 0.5 mm or less. The above-described lower limit and upper limit of the thickness of the laminate for an image display device can be arbitrarily combined. Specifically, the above-described thickness is preferably 0.02 mm or more and 1.0 mm or less, more preferably 0.03 mm or more and 0.7 mm or less, and still more preferably 0.05 mm or more and 0.5 mm or less.

A method for manufacturing the laminate for an image display device according to the embodiment is not particularly limited.

For example, the adhesive composition may be applied to the image display device component to form an adhesive sheet, or an adhesive sheet with a mold release film may be formed in advance and then bonded to the image display device component.

A method of bonding the adhesive sheet to the surface of the image display device component having a step is not particularly limited, and, for example, known methods such as roll bonding, press bonding using a parallel plate, and diaphragm bonding can be used. A bonding environment may be an air bonding method of carrying out bonding at normal pressure or a vacuum bonding method of carrying out bonding under reduced pressure.

When bonding the adhesive sheet, a heating treatment may be performed. A heating temperature during the heating treatment is preferably 40° C. or higher and 100° C. or lower, more preferably 50° C. or higher and 90° C. or lower, and still more preferably 55° C. or higher and 85° C. or lower.

When bonding the adhesive sheet, a pressing pressure may be applied to the laminate together with the heating treatment.

In addition, when bonding the adhesive sheet, a pressurization treatment using an autoclave may be performed together with the heating treatment.

### <Flexible Image Display Device>

Still another embodiment of the present invention relates to a flexible image display device.

The “flexible image display device” means an image display device that does not leave any bending marks even after repeated bending, folding, or rolling up operations, and, when released from the bent, folded, or rolled up state, quickly recovers to the state before the operation and displays images without distortion.

The flexible image display device according to the embodiment includes the laminate for an image display device according to the embodiment of the present invention. In the flexible image display device according to the embodiment, for example, the laminate for an image display device is disposed on a side of an image display panel opposite to the viewer side, that is, on a light source side.

In the flexible image display device according to the embodiment, other members may be further laminated between the image display panel and the laminate for an image display device according to the embodiment of the present invention or on a side of the laminate for an image display device according to the embodiment of the present invention opposite to the image display panel. Examples of the other members include the same image display device components as those mentioned in the description of the laminate for an image display device according to the embodiment.

In the flexible image display device according to the embodiment, even when the image display device component on the contact surface with the adhesive sheet has a step with, for example, a height difference of 2 μm or more, the adhesive sheet follows and absorbs the step, suppressing the generation of bubbles, and also suppresses delamination or cracking even when bent, folded, or rolled up in a low-temperature environment.

### <Photocurable Adhesive Sheet>

Another embodiment of the present invention relates to a photocurable adhesive sheet.

The photocurable adhesive sheet according to the embodiment is an adhesive sheet before irradiation with light, and is formed of an adhesive composition containing the (meth)acrylic copolymer (A).

The photocurable adhesive sheet according to the embodiment of the present invention is a photocurable adhesive sheet in which the (meth)acrylic copolymer (A) has a constitutional unit derived from a monomer M which is excited by irradiation with an active energy ray to generate an active species, and the following requirements (1′) and (2′) are satisfied.

Requirement (1′): when the photocurable adhesive sheet is irradiated with an active energy ray having a wavelength of 365 nm with an irradiation amount within an integrated light amount of 1,000 to 5,000 mJ/cm2, a storage shear modulus at −20° C. (G′(−20° C.)), which is obtained by a dynamic viscoelasticity measurement in a shear mode at a frequency of 1 Hz, is 10 kPa or more and 1,000 kPa or less.

Requirement (2′): when the photocurable adhesive sheet is irradiated with an active energy ray having a wavelength of 365 nm with an irradiation amount within an integrated light amount of 1,000 to 5,000 mJ/cm2, a maximum strain value (γₘₐₓ) when a stress of 2 kPa is applied at 60° C. for 600 seconds is less than 80%.

In addition, details of the photocurable adhesive sheet are the same as the contents described in the adhesive sheet.

### Adhesive Composition

Another embodiment of the present invention relates to an adhesive composition.

The adhesive composition according to the embodiment is used for forming a photocurable adhesive sheet and an adhesive sheet, and contains a (meth)acrylic copolymer (A).

The adhesive composition is the same as the content described in the adhesive sheet.

The present invention is not limited to the embodiments described above. Within a range not departing from the gist of the present invention, it is possible to appropriately substitute the constituent elements in the above-described embodiments with known constituent elements, and the above-described modification examples may be appropriately combined.

### EXAMPLES

A more detailed description of the present invention using Examples and Comparative Examples will be given below. However, the present invention is not limited to these examples in any way. “part” in Examples means “part by mass”.

Measurement and evaluation in Examples were carried out by the methods shown below.

### (Molecular Weight of Macromonomer)

A 0.2% by mass tetrahydrofuran solution of a macromonomer was prepared, and a weight-average molecular weight (Mw) in terms of standard polystyrene was determined under the following conditions.
GPC device: “HLC-8320” manufactured by Tosoh Corporation
Column: the following columns manufactured by Tosoh Corporation were used by being connected in series; as a guard column, “TSK guard column Super HZ-L” (4.6 mmID×2.0 cmL), manufactured by Tosoh Corporation, was used; two “TSKgel Super HZM-M” (4.6 mmID×15 cmL) and one “TSKgel Super HZ2000” (4.6 mmID×15 cmL) were used.
Injection volume: 10 μL
Eluent: tetrahydrofuran (stabilizer: BHT)
Flow rate: 0.35 mL/min
Column temperature: 40° C.

### (Molecular Weight of (Meth)Acrylic Copolymer)

A 0.27% by mass tetrahydrofuran solution of a (meth)acrylic copolymer was prepared, and a weight-average molecular weight (Mw) in terms of standard polystyrene was determined under the following conditions.
GPC device: “HLC-8320” manufactured by Tosoh Corporation
Column: two columns “TSKgel Super HZM-H” (6.0 mmID×15 cmL), manufactured by Tosoh Corporation, were connected in series and used; as a guard column, “TSK guard column Super HZ-H” (4.6 mmID×3.5 cmL), manufactured by Tosoh Corporation, was used.
Injection volume: 10 μl
Eluent: tetrahydrofuran (stabilizer: BHT)
Flow rate: 0.5 mL/min
Column temperature: 40° C.

### (Non-Volatile Content and Volatile Content)

Approximately 1 g of a sample was placed on an aluminum dish, dried in an oven equipped with a blower at 105° C. for 2 hours, the mass before and after the drying was measured on an electronic balance, and the concentration of non-volatile content was obtained according to the following expression.

$$Concentration of non - volatile content ( \% ) = ( Mass of sample after drying ( g ) / Mass of sample before drying ( g ) ) \times 100$$

A concentration of volatile content was determined from the determined concentration of non-volatile content according to the following expression.

$$Concentration of volatile content ( \% ) = 100 - Concentration of non - volatile content ( \% )$$

### (Adhesive Force)

The mold release film on one side was removed from the adhesive sheet with a mold release film produced in each example, and a polyethylene terephthalate (PET) film (thickness: 50 μm) was bonded thereto as a backing film using a hand roller. The laminate was cut into strips with a width of 10 mm and a length of 150 mm, the remaining mold release film was peeled off, and a PET film (manufactured by Mitsubishi Chemical Corporation, DIAFOIL S-100, thickness: 50 μm), which had been bonded to soda-lime glass in advance, was bonded to the exposed adhesive surface using a hand roller. The obtained laminate was subjected to an autoclave treatment (60° C., gauge pressure of 0.2 MPa, and 20 minutes) for finish bonding, thereby producing a measurement sample of adhesive force.

For the obtained measurement sample of adhesive force, the adhesive sheet was peeled off together with the backing film from the PET film bonded to the soda-lime glass while being pulled at a peeling rate of 300 mm/min at an angle of 180° in an atmosphere of 23° C. and 50% RH or in an atmosphere of 60° C. and 10% RH, and a tensile strength (N/cm) was measured with a load cell to obtain an adhesive force.

### (Storage Shear Modulus G′)

The mold release film on one side was removed from an adhesive sheet with a mold release film, which was produced in each example, and the adhesive sheet was repeatedly laminated with a hand roller to adjust the thickness to approximately 0.8 mm, and punched out into a circle with a diameter of 8 mm to produce a sample. The obtained sample was placed in a rheometer (“DHR-2” manufactured by TA Instruments), a dynamic viscoelasticity measurement was performed under the conditions of a measurement jig of an 8 mm-diameter parallel plate, a frequency of 1 Hz, a measurement temperature of −50° C. to 150° C., and a temperature rising rate of 5° C./min, and a value of storage shear modulus G′ at −20° C., 25° C., 30° C., 60° C., and 80° C. was read.

### (Glass Transition Temperature)

A temperature at which Tan δ was maximized was read as the glass transition temperature (Tg), from the dynamic viscoelasticity spectrum obtained by the measurement of the storage shear modulus G′.

### (Creep Test)

The mold release film on one side was removed from an adhesive sheet with a mold release film, which was produced in each example, and the adhesive sheet was repeatedly laminated with a hand roller to adjust the thickness to approximately 0.8 mm, and punched out into a circle with a diameter of 8 mm to produce a sample. The obtained sample was placed in a rheometer (“DHR-2” manufactured by TA Instruments), a stress was applied under conditions of a measurement jig: a parallel plate having a diameter of 8 mm, a temperature of 60° C., and a pressure of 2 kPa, a strain (%) after 600 seconds was measured, and the value was defined as the maximum strain value (γₘₐₓ). Thereafter, the stress was released, a strain (%) after 600 seconds was measured, the value was defined as the residual strain value (γₘᵢₙ), and the restoration rate was calculated from the following expression.

$$Restoration rate ( \% ) = [ ( {γ}_{max} - {γ}_{min} ) / {γ}_{max} ] \times 100$$

### (Gel Fraction)

The mold release film was removed from the adhesive sheet with a mold release film, which was produced in each of Examples, to produce a sample.

The sample, weighed in advance, was wrapped with an SUS wire mesh of 150 mesh, and immersed in ethyl acetate at 23° C. for 24 hours. Thereafter, the sample was dried at 70° C. for 4.5 hours, and a mass of the insoluble sample remaining in the wire mesh after the immersion in ethyl acetate was measured. A mass percentage of the insoluble sample remaining in the wire mesh with respect to the mass of the sample before the immersion in ethyl acetate was calculated as a gel fraction (%).

When the irradiation conditions (light source, integrated light amount, and the like) of the active energy ray to the adhesive composition were the same, it can be said that the sensitivity of the adhesive composition to the active energy ray was higher, as the gel fraction of the adhesive sheet was higher.

### (Used Material)

MBP: 4-methacryloyloxybenzophenone (monomer M having a structure which generates a radical by extracting hydrogen from a hydrogen donor upon excitation)
HHMPMA: 2-[4-(2-hydroxy-2-methyl-1-oxopropyl)phenoxy]ethyl methacrylate (monomer M having a structure which generates a radical by cleaving and decomposing a single bond thereof upon excitation)
2EHA: 2-ethylhexyl acrylate
nBA: n-butyl acrylate
4HBA: 4-hydroxybutyl acrylate
SLMA: mixture of an alkyl methacrylate with an alkyl group having 12 carbon atoms and an alkyl methacrylate with an alkyl group having 13 carbon atoms (“Acrylic Ester SL” manufactured by Mitsubishi Chemical Corporation)
AMBN: 2,2′-azobis(2-methylbutyronitrile)

### <Photocurable Compound (B)>

B-1: bifunctional urethane acrylate (“SHIKOH UV-3700B” manufactured by Mitsubishi Chemical Corporation, Mw: 38,000)
B-2: propoxylated pentaerythritol tri- and tetraacrylate (“ATM-4PL” manufactured by Shin-Nakamura Chemical Co., Ltd.)
B-3: monofunctional urethane acrylate having a polypropylene glycol skeleton (however, containing a small amount of bifunctional product) (“PEM-X264” manufactured by Asahi Glass Co., Ltd., Mw: 15,000)

### <Photoinitiator (C)>

C-1: mixture of 4-methylbenzophenone and 2,4,6-trimethylbenzophenone (hydrogen abstraction-type) (“Esacure TZT” manufactured by IGM Resins, Inc.)

### Production Example 1

100 parts of SLMA, 0.00075 parts of bis[(difluoroboryl)diphenylglyoxymate]cobalt(II) as a chain transfer agent, and 58 parts of ethyl acetate were charged into a four-necked flask equipped with a stirrer, a thermometer, a cooling tube, and a nitrogen gas inlet, and oxygen was replaced by nitrogen bubbling. Next, 0.4 parts of AMBN as a polymerization initiator and 2 parts of ethyl acetate were added thereto. Next, the external temperature was raised to 90° C. in a water bath, and the reaction was carried out in a reflux state for 2 hours. Next, 0.2 parts of AMBN and 20 parts of ethyl acetate were added dropwise thereto over 1 hour, and the reflux state was further maintained for 2 hours. Thereafter, the reaction solution was cooled to 40° C. to obtain a solution containing a macromonomer (SLMA-MM). By adding ethyl acetate to the solution, the concentration of non-volatile content was adjusted to 50% by mass. The weight-average molecular weight of the macromonomer (SLMA-MM) was 9,420.

### Example 1

### <Production of (Meth)Acrylic Copolymer>

25 parts of ethyl acetate, 2 parts of isopropyl alcohol (IPA), and 6.8 parts of the macromonomer (SLMA-MM) solution (concentration: 50% by mass) were charged into a four-necked flask equipped with a stirrer, a thermometer, a cooling tube, and a nitrogen gas inlet, and the external temperature was raised to 85° C. in a water bath under nitrogen gas ventilation. After the reflux state was stabilized, a mixture consisting of 20 parts of ethyl acetate, 28 parts of 2EHA, 61 parts of nBA, 4 parts of 4HBA, 0.2 parts of MBP, and 0.13 parts of NYPER BK40 MT (manufactured by NOF CORPORATION) was added dropwise thereto over 4 hours. After finishing the dropwise addition and retaining for 1 hour, a mixture consisting of 0.3 parts of PEROCTA O (manufactured by NOF CORPORATION) and 15 parts of ethyl acetate were added thereto over 1 hour. After retaining for 2 hours, 0.5 parts of “IRGANOX 1010” (trade name, manufactured by BASF), as an antioxidant, and 23 parts of ethyl acetate were added thereto, and the mixture was cooled to room temperature to obtain a composition containing (meth)acrylic copolymers (SLMA-MM/2EHA/nBA/4HBA/MBP (mass ratio)=6.8/28/61/4/0.2, weight-average molecular weight (Mw): 700,000).

### <Production of Adhesive Sheet>

The composition obtained in the production of the (meth)acrylic copolymer described above was used as an adhesive composition. The adhesive composition was developed in a sheet shape on a mold release film (manufactured by Mitsubishi Chemical Corporation, a PET film subjected to a silicone release treatment) having a thickness of 100 μm such that a thickness after drying was 50 μm. Next, the sheet-shaped adhesive composition together with the mold release film was put into a dryer heated to 90° C. and held for 10 minutes to dry the adhesive composition (volatilize the solvent contained in the adhesive composition). Next, a mold release film (manufactured by Mitsubishi Chemical Corporation, a PET film subjected to a silicone release treatment) having a thickness of 75 μm was laminated on the sheet-shaped adhesive composition which had been dried.

Next, the adhesive composition was irradiated with an active energy ray through the mold release film using a high-pressure mercury lamp such that the integrated light amount at a wavelength of 365 nm was 4,000 mJ/cm², thereby obtaining an adhesive sheet with a mold release film, in which the mold release film was laminated on both sides of an adhesive sheet having a thickness of 50 μm.

### Examples 2 to 16 and Comparative Example 1

An adhesive sheet with a mold release film was produced in the same manner as in Example 1, except that the copolymerization formulation of the (meth)acrylic copolymer (A), the formulation of the adhesive composition, and the amount of irradiation with the active energy ray were changed as shown in Tables 1 and 2. In Tables 1 and 2, the formulation amounts of the photocurable compound (B) and the photoinitiator (C) are ratios (parts) with respect to 100 parts of the (meth)acrylic copolymer.

Tables 1 and 2 show the results of measurement and evaluation of the adhesive sheet of each example.

TABLE 1

| | | | | | Exam- | Exam- | Exam- | Exam- | Exam- | Exam- | Exam- | Exam- |
|---|---|---|---|---|---|---|---|---|---|---|---|---|
| | | | | | ple 1 | ple 2 | ple 3 | ple 4 | ple 5 | ple 6 | ple 7 | ple 8 |
| Adhesive | (Meth)acrylic | Monomer | MBP | Part | 0.2 | 0.2 | 0.2 | 0.5 | 1 | 0.2 | 0.5 | 0.5 |
| composition | copolymer (A) | M | HHMPMA | Part | — | — | — | — | — | — | — | — |
| | | (a1) | 2EHA | Part | 28 | 28 | 28 | 28 | 28 | 50 | 50 | 79.5 |
| | | | nBA | Part | 61 | 61 | 61 | 61 | 61 | 38.8 | 38.5 | — |
| | | (a3) | 4HBA | Part | 4 | 4 | 4 | 4 | 4 | 4 | 4 | 20 |
| | | (a9) | SLMA-MM | Part | 6.8 | 6.8 | 6.8 | 6.5 | 6 | 7 | 7 | — |
| | | Weight-average | | 10k | 70 | 70 | 70 | 73 | 73 | 69 | 63 | 46 |
| | | molecular weight (Mw) | | | | | | | | | | |
| | Photocurable | B-1 | | Part | — | 1.5 | 1.5 | 1.5 | 1.5 | — | — | — |
| | compound (B) | B-2 | | Part | — | — | — | — | — | — | — | — |
| | | B-3 | | Part | — | — | — | — | — | — | — | 25 |
| | Photoinitiator | C-1 | | Part | — | — | 1.5 | — | — | — | — | — |
| | (C) | | | | | | | | | | | |
| Adhesive | Integrated light | Wavelength of 365 nm | | mJ/cm² | 4000 | 4000 | 4000 | 4000 | 4000 | 4000 | 4000 | 3000 |
| sheet | amount | | | | | | | | | | | |

| | | | | | | | | | | |
|---|---|---|---|---|---|---|---|---|---|---|
| Adhesive force | 23° C., 50% RH | N/cm | 3.2 | 3.5 | 2.6 | 2.1 | 1.1 | 2.8 | 1.8 | 1.5 |
| | 60° C., 10% RH | N/cm | 1.2 | 1 | 0.9 | 0.7 | 0.2 | 0.7 | 0.5 | 0.3 |
| Storage shear | −20° C. | kPa | 210 | 204 | 221 | 217 | 243 | 160 | 172 | 111 |
| modulus (G′) | 25° C. | kPa | 38 | 37 | 45 | 52 | 73 | 23 | 33 | 16 |
| | 30° C. | kPa | 34 | 33 | 41 | 48 | 71 | 20 | 31 | 14 |
| | 60° C. | kPa | 21 | 21 | 28 | 40 | 67 | 12 | 24 | 10 |
| | 80° C. | kPa | 17 | 17 | 24 | 38 | 68 | 9 | 23 | 9 |

| | | | | | | | | | |
|---|---|---|---|---|---|---|---|---|---|
| Glass transition temperature (Tg) | ° C. | −41 | −41 | −42 | −41 | −40 | −42 | −42 | −44 |
| Maximum strain value (γₘₐₓ) | % | 23 | 23 | 14 | 7 | 3 | 39 | 10 | 29 |
| Restoration rate | % | 96 | 96 | 97 | 98 | 99 | 97 | 99 | 98 |
| Gel fraction | % | 75 | 75 | 84 | 86 | 91 | 72 | 83 | 72 |

TABLE 2

| | | | | | | | | | | | | | Compara- |
|---|---|---|---|---|---|---|---|---|---|---|---|---|---|
| | | | | | | | | | | | | | tive |
| | | | | | Exam- | Exam- | Exam- | Exam- | Exam- | Exam- | Exam- | Exam- | Exam- |
| | | | | | ple 9 | ple 10 | ple 11 | ple 12 | ple 13 | ple 14 | ple 15 | ple 16 | ple 1 |
| Adhesive | (Meth)acrylic | Mono- | MBP | Part | — | — | — | — | — | — | — | — | — |
| compo- | copolymer | mer M | HHMPMA | Part | 0.5 | 0.5 | 0.5 | 0.5 | 0.5 | 0.5 | 1 | 1 | — |
| sition | (A) | (a1) | 2EHA | Part | 28 | 28 | 28 | 28 | 28 | 28 | 50 | 79 | 28 |
| | | | nBA | Part | 61 | 61 | 61 | 61 | 61 | 61 | 38 | — | 61 |
| | | (a3) | 4HBA | Part | 4 | 4 | 4 | 4 | 4 | 4 | 4 | 20 | 4 |
| | | (a9) | SLMA- | Part | 6.5 | 6.5 | 6.5 | 6.5 | 6.5 | 6.5 | 7 | — | 7 |
| | | | MM | | | | | | | | | | |
| | | Weight-average | | 10k | 76 | 76 | 76 | 76 | 76 | 76 | 66 | 55 | 69 |
| | | molecular weight | | | | | | | | | | | |
| | | (Mw) | | | | | | | | | | | |
| | Photocurable | B-1 | | Part | — | 1.5 | — | — | — | — | — | — | 1.5 |
| | compound | B-2 | | Part | — | — | 0.5 | 1.5 | — | — | — | — | — |
| | (B) | B-3 | | Part | — | — | — | — | — | — | — | 25 | — |
| | Photoinitiator | C-1 | | Part | — | — | — | — | 0.5 | 1.5 | — | — | 1.5 |
| | (C) | | | | | | | | | | | | |

| | | | | | | | | | | | | |
|---|---|---|---|---|---|---|---|---|---|---|---|---|
| Adhesive | Integrated | Wavelength of 365 | mJ/cm² | 4000 | 4000 | 4000 | 4000 | 4000 | 4000 | 4000 | 3000 | 4000 |
| sheet | light amount | nm | | | | | | | | | | |
| | Adhesive | 23° C., 50% RH | N/cm | 5 | 5.6 | 4.0 | 3.6 | 4.3 | 3.2 | 3.5 | 2.5 | 3.9 |
| | force | 60° C., 10% RH | N/cm | 1.6 | 1.7 | 1.2 | 1.2 | 1.4 | 1.4 | 1.1 | 0.7 | 1.2 |
| | Storage shear | −20° C. | kPa | 221 | 208 | 207 | 236 | 195 | 206 | 176 | 118 | 192 |
| | modulus (G′) | 25° C. | kPa | 36 | 36 | 35 | 42 | 35 | 39 | 24 | 14 | 32 |
| | | 30° C. | kPa | 32 | 32 | 31 | 38 | 31 | 35 | 21 | 12 | 28 |
| | | 60° C. | kPa | 16 | 17 | 18 | 23 | 17 | 20 | 12 | 7 | 14 |
| | | 80° C. | kPa | 12 | 12 | 13 | 19 | 12 | 16 | 9 | 6 | 10 |

| | | | | | | | | | | |
|---|---|---|---|---|---|---|---|---|---|---|
| Glass transition temperature (Tg) | ° C. | −41 | −41 | −41 | −40 | −41 | −39 | −42 | −43 | −41 |
| Maximum strain value (γₘₐₓ) | % | 70 | 55 | 34 | 20 | 45 | 27 | 46 | 52 | 80 |
| Restoration rate | % | 89 | 91 | 95 | 97 | 93 | 96 | 96 | 98 | 86 |
| Gel fraction | % | 67 | 69 | 73 | 78 | 72 | 78 | 72 | 72 | 73 |

As shown in Tables 1 and 2, the adhesive sheets of Examples were adhesive sheets having high sensitivity to active energy rays and excellent flexibility and shape stability.

Among the above, in the adhesive sheets of Examples 9 to 16, in which the monomer M had a structure that generated a radical by cleaving and decomposing a single bond thereof upon excitation, the adhesive sheets tended to have an improved adhesive force as compared with the adhesive sheets in which the monomer M having a hydrogen abstraction-type radical generating group was used.

On the other hand, the adhesive sheet of Comparative Example had a high maximum strain value (γₘₐₓ) when a stress of 2 kPa was applied at 60° C. for 600 seconds, and thus had poor shape stability.

### INDUSTRIAL APPLICABILITY

According to the present invention, it is possible to provide an adhesive sheet having high sensitivity to active energy rays and capable of being cured with high efficiency; and an adhesive sheet with a mold release film, an adhesive sheet for a flexible image display device component, a laminate for an image display device, and a flexible image display device, each of which uses the adhesive sheet.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An adhesive sheet formed of an adhesive composition containing a (meth)acrylic copolymer (A),
wherein the (meth)acrylic copolymer (A) has a constitutional unit derived from a monomer M which is excited by irradiation with an active energy ray to generate an active species, and
the adhesive sheet satisfies the following requirements (1) and (2):
the requirement (1): a storage shear modulus (G′(−20° C.)) at −20° C., which is obtained by a dynamic viscoelasticity measurement in a shear mode at a frequency of 1 Hz, is 10 kPa or more and 1,000 kPa or less; and
the requirement (2): a maximum strain value (γₘₐₓ) when a stress of 2 kPa is applied at 60° C. for 600 seconds is less than 80%.

2. The adhesive sheet according to claim 1,
wherein a storage shear modulus (G′(30° C.)) at 30° C., which is obtained by the dynamic viscoelasticity measurement in the shear mode at the frequency of 1 Hz, is 1,000 kPa or less.

3. The adhesive sheet according to claim 1,
wherein a glass transition temperature (Tg) defined by a maximal value of Tan δ, which is obtained by the dynamic viscoelasticity measurement in the shear mode at the frequency of 1 Hz, is −20° C. or lower.

4. The adhesive sheet according to claim 1,
wherein a restoration rate calculated by the following expression from the maximum strain value (γₘₐₓ) when the stress of 2 kPa is applied at 60° C. for 600 seconds and a residual strain value (γₘᵢₙ) after 600 seconds from a point of time when the stress is removed is 60% or more,
$$restoration rate ( \% ) = [ ( {γ}_{max} - {γ}_{min} ) / {γ}_{max} ] \times 100 .$$

5. The adhesive sheet according to claim 1,
wherein a gel fraction is 30% or more.

6. The adhesive sheet according to claim 1,
wherein a contained amount of the constitutional unit derived from the monomer M is 0.01% to 20% by mass with respect to all constitutional units constituting the (meth)acrylic copolymer (A).

7. The adhesive sheet according to claim 1,
wherein the monomer M has a structure in which, when being excited by irradiation with an active energy ray, a single bond in the monomer M is cleaved and decomposed to generate a radical.

8. The adhesive sheet according to claim 1,
wherein the monomer M has a structure in which, when being excited by irradiation with an active energy ray, a hydrogen is extracted from a hydrogen donor in the adhesive composition to generate a radical.

9. The adhesive sheet according to claim 1,
wherein the monomer M is represented by Formula (I), 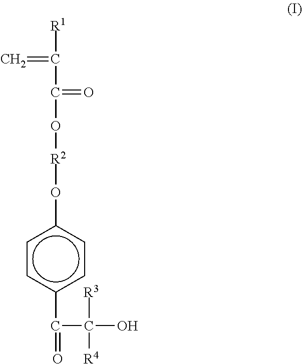
in the formula, R¹ represents a hydrogen atom, a methyl group, or an ethyl group, R² represents a linear or branched alkylene group having 1 to 5 carbon atoms, R³ and R⁴ each independently represent a linear or branched alkyl group having 1 to 5 carbon atoms, and R³ and R⁴ may be bonded to each other to form a ring.

10. The adhesive sheet according to claim 1,
wherein the (meth)acrylic copolymer (A) has a constitutional unit derived from a linear or branched alkyl (meth)acrylate (a1) with an alkyl group having 4 to 30 carbon atoms.

11. The adhesive sheet according to claim 1,
wherein the (meth)acrylic copolymer (A) is a block copolymer or a graft copolymer.

12. The adhesive sheet according to claim 1,
wherein the (meth)acrylic copolymer (A) has a constitutional unit derived from a macromonomer (a9).

13. The adhesive sheet according to claim 12,
wherein the macromonomer (a9) includes a constitutional unit derived from an alkyl (meth)acrylate with an alkyl group having 9 to 30 carbon atoms.

14. The adhesive sheet according to claim 1,
wherein the adhesive composition contains a photocurable compound (B).

15. The adhesive sheet according to claim 1,
wherein the adhesive composition contains a photoinitiator (C).

16. The adhesive sheet according to claim 1,
wherein the adhesive composition contains a photocurable compound (B) and a photoinitiator (C).

17. The adhesive sheet according to claim 14,
wherein the photocurable compound (B) includes a polyfunctional urethane (meth)acrylate.

18. An adhesive sheet with a mold release film, comprising:
the adhesive sheet according to claim 1; and
a mold release film laminated on at least one surface of the adhesive sheet.

19. An adhesive sheet for a flexible image display device component comprising:
the adhesive sheet according to claim 1.

20. A laminate for an image display device, comprising:
two image display device components; and
the adhesive sheet according to claim 1,
wherein the two image display device components are laminated through the adhesive sheet, and
at least one of the image display device components has a step with a height difference of 2 μm or more on a contact surface with the adhesive sheet.

21. A flexible image display device comprising:
the laminate for an image display device according to claim 20.

22. A photocurable adhesive sheet formed of an adhesive composition containing a (meth)acrylic copolymer (A),
wherein the (meth)acrylic copolymer (A) has a constitutional unit derived from a monomer M which is excited by irradiation with an active energy ray to generate an active species, and
the photocurable adhesive satisfies the following requirements (1′) and (2′):
the requirement (1′): when the photocurable adhesive sheet is irradiated with an active energy ray having a wavelength of 365 nm with an irradiation amount within an integrated light amount of 1,000 to 5,000 mJ/cm², a storage shear modulus at −20° C. (G′(−20° C.)), which is obtained by a dynamic viscoelasticity measurement in a shear mode at a frequency of 1 Hz, is 10 kPa or more and 1,000 kPa or less; and
the requirement (2′): when the photocurable adhesive sheet is irradiated with an active energy ray having a wavelength of 365 nm with an irradiation amount within an integrated light amount of 1,000 to 5,000 mJ/cm², a maximum strain value (Ymax) when a stress of 2 kPa is applied at 60° C. for 600 seconds is less than 80%.

23. An adhesive composition comprising:
a (meth)acrylic copolymer (A),
wherein the (meth)acrylic copolymer (A) has a constitutional unit derived from a monomer M which is excited by irradiation with an active energy ray to generate an active species, and
the adhesive composition satisfies the following requirements (1″) and (2″):
the requirement (1″): when the adhesive composition is dried to form a photocurable adhesive sheet, and the photocurable adhesive sheet is irradiated with an active energy ray having a wavelength of 365 nm with an irradiation amount within an integrated light amount of 1,000 to 5,000 mJ/cm² to form an adhesive sheet, a storage shear modulus at −20° C. (G′(−20° C.)), which is obtained by a dynamic viscoelasticity measurement in a shear mode at a frequency of 1 Hz, is 10 kPa or more and 1,000 kPa or less; and
the requirement (2″): when the adhesive composition is dried to form a photocurable adhesive sheet, and the photocurable adhesive sheet is irradiated with an active energy ray having a wavelength of 365 nm with an irradiation amount within an integrated light amount of 1,000 to 5,000 mJ/cm² to form an adhesive sheet, a maximum strain value (γₘₐₓ) when a stress of 2 kPa is applied at 60° C. for 600 seconds is less than 80%.
